(19) United States
(12) Patent Application Publication
(10) Pub. No.: US 2026/0270511 A1
(43) Pub. Date: Sep. 10, 2026

(54) METHOD FOR REMOVING MODERATED CONTENT FROM A VIDEO STREAMING PLATFORM

(71) Applicant: Mux, Inc., San Francisco, CA (US)

(72) Inventors: Phil Cluff, San Francisco, CA (US); Christian Pillsbury, San Francisco, CA (US); Adam Brown, San Francisco, CA (US); Jonathan Dahl, San Francisco, CA (US)

(21) Appl. No.: 19/558,837

(22) Filed: Mar. 6, 2026

Related U.S. Application Data
(60) Provisional application No. 63/768,003, filed on Mar. 6, 2025.
(60) Provisional application No. 63/921,776, filed on Nov. 20, 2025.

(51) Int. Cl. H04N 21/454; G06T 3/40; H04N 21/44

(52) U.S. Cl. CPC H04N 21/4542; G06T 3/40; H04N 21/44008

(57) ABSTRACT

One variation of the method includes accessing a video file including a set of mezzanine segments and, for a first mezzanine segment in the set of mezzanine segments: extracting a frame in a first resolution from the mezzanine segment; converting the frame into a representative image, in a second resolution less than the first resolution; serving the representative image to an image processing model for detection of moderated content in the representative image; and, in response to the image processing model returning failure to detect moderated content in the representative image, initiating transcoding of each mezzanine segment, in the set of mezzanine segments, into a first rendition segment, in a set of rendition segments, in a first rendition, and enabling distribution of the set of rendition segments to a video player.

### CROSS-REFERENCE TO RELATED APPLICATIONS

This Application claims the benefit of U.S. Provisional Application Nos. 63/921,776, filed on 20 Nov. 2025, and 63/768,003, filed on 06 Mar. 2025, each of which is incorporated in its entirety by this reference.

### TECHNICAL FIELD

This invention relates generally to the field of internet-based content streaming and, more specifically, to a new and useful method for removing moderated content from a video streaming platform.

### BRIEF DESCRIPTION OF THE FIGURES

FIG. 1 is a flowchart representation of a first method;

FIG. 2 is a flowchart representation of a variation of the first method;

FIG. 3 is a flowchart representation of a variation of the first method;

FIG. 4 is a flowchart representation of a second method;

FIGS. 5A, 5B, and 5C are flowchart representations of one variation of the second method; and

FIGS. 6A and 6B are flowchart representations of one variation of the second method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

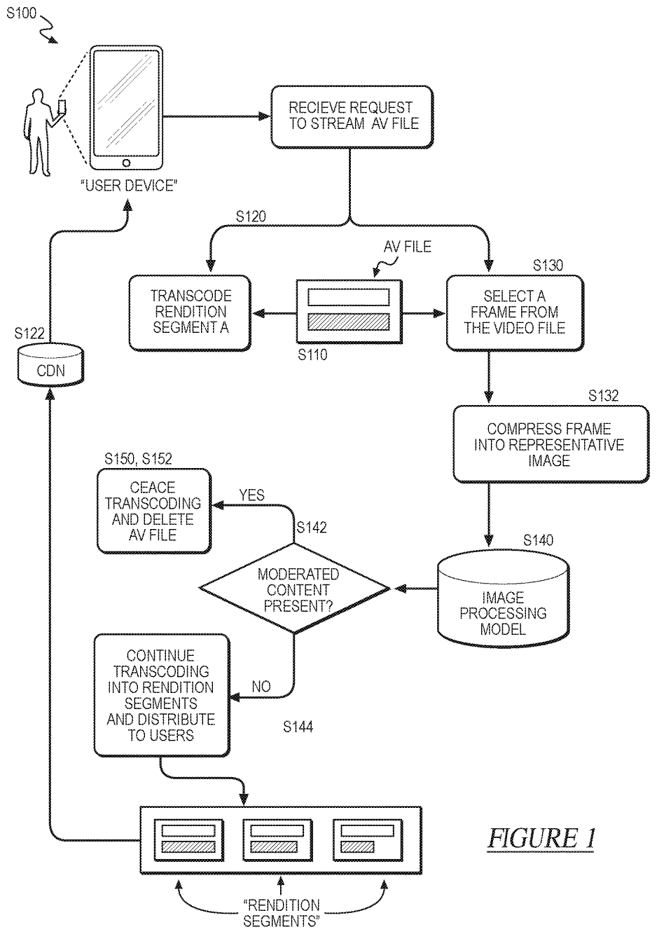

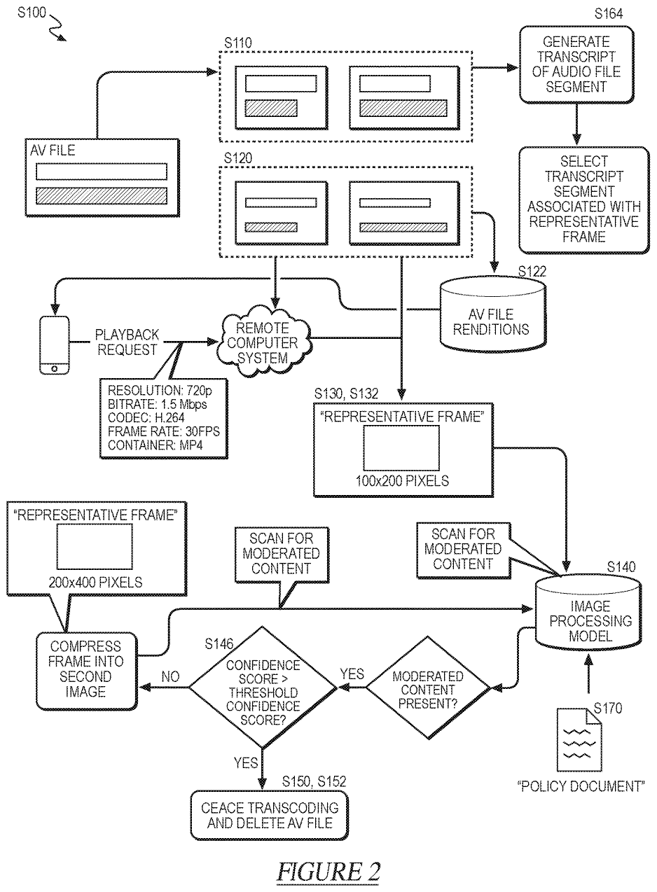

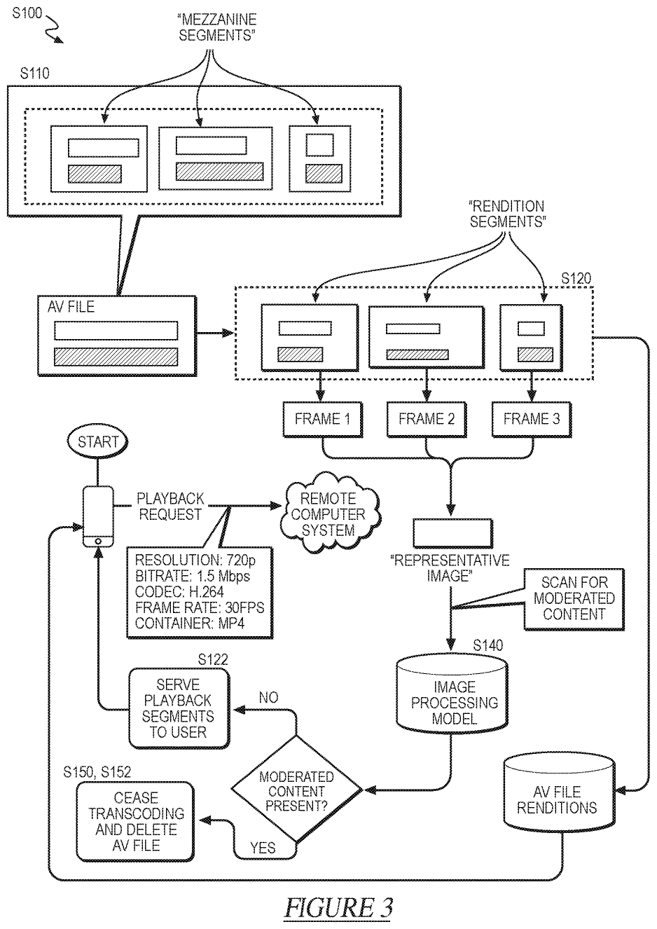

As shown in FIGS. 1-3, a first method includes accessing a video including a set of mezzanine segments in Block S110 and, in response to receiving a first request, at a first time, for a first rendition segment of the video in a first rendition from a first video player: initiating transcoding of a first mezzanine segment, in the set of mezzanine segments, into the first rendition segment in the first rendition in Block S120; enabling distribution of the first rendition segment to the video player in Block S122; extracting a first frame in a first resolution from the video in Block S130; converting the first frame into a first representative image in a second resolution less than the first resolution in Block S132; serving the first representative image to an image processing model for detection of moderated content in the first representative image in Block S140; and, in response to the image processing model returning detection of moderated content in the first representative image, disabling transcoding of the set of mezzanine segments into rendition segments in the first rendition in Block S150 and disabling distribution of rendition segments in the first rendition of the video in Block S152.

### 1.1.1 Variation: Pre-Transcoding Moderated Content Detection

One variation of the first method includes accessing a video file including a set of mezzanine segments in Block S110 and, at a first time, for a first mezzanine segment in the set of mezzanine segments: extracting a first frame in a first resolution from the first mezzanine segment in Block S130; converting the first frame into a first representative image in a second resolution less than the first resolution in Block S132; serving the first representative image to an image processing model for detection of moderated content in the first representative image in Block S140; and, in response to the image processing model returning failure to detect moderated content in the first representative image, initiating transcoding of the first mezzanine segment, in the set of mezzanine segments, into a first rendition segment in a first rendition in Block S120 and enabling distribution of the first rendition segment to a video player in Block S122.

### 1.1.2 Variation: Whole-Video Moderation Detection

Another variation of the first method S100 includes accessing a video file including a set of mezzanine segments in Block S110 and, for each mezzanine segment in the set of mezzanine segments: extracting a frame in a first resolution from the mezzanine segment in Block S130; converting the frame into a representative image, in a set of representative images, in a second resolution less than the first resolution in Block S132; and serving the representative image to an image processing model for detection of moderated content in the representative image in Block S140.

This variation of the method S100 further includes: in response to the image processing model returning failure to detect moderated content in each representative image in the set of representative images: initiating transcoding of each mezzanine segment, in the set of mezzanine segments, into a first rendition segment, in a set of rendition segments, in a first rendition in Block S120; and enabling distribution of the set of rendition segments to a video player in Block S122.

### 1.1.3 Variation: Manifest File

As shown in FIG. 1, one variation of the first method includes: segmenting a video file into a set of mezzanine segments, each mezzanine segment in the set of mezzanine segments including a portion of the video file; generating a manifest file for the video file, the manifest file representing a first rendition of the video file characterized by a first bitrate and a first resolution and a second rendition of the video file characterized by a second bitrate less than the first bitrate and a second resolution less than the first resolution; in response to receiving a first request for a playback segment of the video file in a first rendition from a video player, initiating transcoding of the playback segment, in the set of mezzanine segments, into the first rendition by a first worker; serving the playback segment from the first worker to the video player; and storing the playback segment in the first rendition in a rendition cache.

The method also includes, in response to receiving the first request for the playback segment of the video file in the first rendition from the video player: serving the playback segment to a second worker for transcoding into a first representative image; passing the representative image to an image processing model with a prompt to scan the representative image for moderated content; and, in response to the image processing model returning confirmation of moderated content present in the representative image, closing the video file, deactivating the manifest, and ceasing transcoding of the set of mezzanine segments.

### 1.1.4 Variation: Escalating Moderation Investigation

In one variation, the first method includes, in response to receiving the first request for the playback segment of the video file in the first rendition from the video player: serving the playback segment to a second worker for transcoding into a first series of representative images of a target resolution and on a target time interval; passing the first set of representative images to an image processing model with a prompt to scan the first set of representative images for moderated content; and receiving a first confidence score for moderated content present in the first set of representative images from the image processing model.

This variation further includes, in response to the first confidence score falling below a threshold score and in response to receiving a second request for a second playback segment of the video file in the first rendition from the video player: initiating transcoding of the second playback segment, in the set of mezzanine segments, into the first rendition by the first worker; serving the second playback segment from the first worker to the video player; and storing the playback segment in the first rendition in the rendition cache.

This variation of the method further includes: adjusting the target resolution proportional to the first confidence score; adjusting the target time interval inversely proportional to the first confidence score; serving the second playback segment to the second worker for transcoding into a second series of representative images of the target resolution and on the target time interval; passing the second set of representative images to the image processing model with the prompt to scan the second set of representative images for moderated content; receiving a second confidence score for moderated content present in the second set of representative images from the image processing model; and, in response to the second confidence score exceeding the threshold score, deactivating the manifest and ceasing transcoding of the set of mezzanine segments.

### 1.1.5 Variation: Preemptive Moderation Prior to Transcoding

Another variation of the first method includes: segmenting a video file into a set of mezzanine segments, each mezzanine segment in the set of mezzanine segments including a portion of the video file; for each mezzanine segment in the set of mezzanine segments, serving the mezzanine segment to a worker for transcoding into a representative image, in a sequence of representative images and passing the representative image to an image processing model with a prompt to scan the representative image for moderated content; and, in response to the image processing model returning confirmation of moderated content present in a representative image in the sequence of representative images, closing the video file and disabling transcoding of the set of mezzanine segments.

This variation of the method further includes, in response to the image processing model returning absence of moderated content present in the sequence of representative images, generating a manifest file for the video file, the manifest file representing: a first rendition of the video file characterized by a first bitrate and a first resolution; and a second rendition of the video file characterized by a second bitrate less than the first bitrate and a second resolution less than the first resolution.

This variation of the first method further includes, in response to the image processing model returning absence of moderated content present in the sequence of representative images and in response to receiving a first request for a playback segment of the video file in a first rendition from an video player: initiating transcoding of the playback segment, in the set of mezzanine segments, into the first rendition by a first worker; serving the playback segment from the first worker to the video player; and storing the playback segment in the first rendition in a rendition cache.

### 1.1.6 Variation: Dynamic Overlay Generation

In yet another variation, the first method includes: segmenting a video file into a set of mezzanine segments, each mezzanine segment in the set of mezzanine segments including a portion of the video file; and generating a manifest file for the video file, the manifest file representing a first rendition of the video file characterized by a first bitrate and a first resolution and a second rendition of the video file characterized by a second bitrate less than the first bitrate and a second resolution less than the first resolution.

This variation of the first method also includes, in response to receiving a first request for a playback segment of the video file in a first rendition from an video player: initiating transcoding of the playback segment, in the set of mezzanine segments, into the first rendition by a first worker; serving the playback segment from the first worker to the video player; and storing the playback segment in the first rendition in a rendition cache.

This variation of the first method also includes, in response to receiving the first request for the playback segment of the video file in the first rendition from the video player: serving the playback segment to a second worker for transcoding into a first representative image, in a set of representative images; passing the first representative image to an image processing model with a prompt to identify a key feature in the first representative image; receiving the key feature from the image processing model; annotating the playback segment with a representation of the key feature; and serving the playback segment, annotated with the representation of the key feature, from the second worker to the video player.

In this variation, the first method can alternatively include, in response to receiving the first request for the playback segment of the video file in the first rendition from the video player: serving the playback segment to a second worker for transcoding into a first representative image, in a set of representative images; passing the first representative image to an image processing model with a prompt to identify a key feature in the first representative image; receiving the key feature from the image processing model; initiating transcoding of the playback segment, in the set of mezzanine segments, into the first rendition including an overlay representing the key feature, by a first worker; serving the playback segment from the first worker to the video player; and storing the playback segment in the first rendition in a rendition cache.

### 1.2 Applications

Generally, the computer system (e.g., a computer network, a computer server) can execute Blocks of a first method to: transcode a first mezzanine segment of a video file into a first rendition segment; extract a particular frame from the mezzanine segment; compress the particular frame into a representative image for the video file (e.g., by transcoding a single frame in a four-second 1080i video clip into a single 320×180-pixel image); serve the representative image to an image processing model with a prompt to scan the representative image for moderated (e.g., copyrighted, explicit) content; and, in response to receiving confirmation of presence of such content, automatically disable further transcoding of the video file and/or deactivate further distribution of the renditions of the video file.

In particular, in response to receiving a request from a video player to access (e.g., stream) a rendition segment of a video file corresponding to a mezzanine segment of the video file not yet validated, the computer system can: extract a particular frame from the mezzanine segment; and transcode the particular frame into a representative image characterized by a (very) low-resolution, such as a single 320 pixel by 180 pixel image frame. The computer system can then serve this representative image to an image processing model with a prompt to identify moderated content within the image frame.

The computer system can concurrently serve the mezzanine segment—corresponding to the request—to another worker for concurrently transcoding into the specified rendition. In response to the image processing model returning confirmation that the representative image excludes moderated content, the computer system can: mark the mezzanine segment of the video file as validated; and release the corresponding rendition segment to the video player.

Thus, in this implementation, the computer system can concurrently transcode a mezzanine segment into a rendition segment and serve a representative image—representing the mezzanine segment—to an image processing model (e.g., a machine learning model, an artificial intelligence mode) for detection of moderated content, thereby limiting latency from receipt of a first request for the corresponding rendition segment to delivery of the rendition segment to the video player.

Alternatively, the computer system can serve the mezzanine segment corresponding to the request to a worker—for transcoding into the specified rendition—in response to the image processing model returning confirmation that the representative image excludes moderated content. Thus, in this implementation, the computer system can: preemptively serve a representative image—representing content in the video file and/or the mezzanine segment—to the image processing model for detection of moderated content; and then transcode the mezzanine segment into a rendition segment.

Therefore, the computer system can: autonomously verify that video files uploaded to a video platform are compliant with terms of service (i.e., exclude moderated content) prior to transcoding and distributing (e.g., streaming) to users; and automatically remove video files that contain such moderated content from the video player.

Furthermore, by limiting (e.g., minimizing) a size of a frame served to the image processing model for moderation analysis, and by offloading detection of moderated content to a model (e.g., a cloud-based artificial intelligence model), the computer system can simultaneously limit computational resources dedicated to moderation detection, decrease latency of detection of moderated content by the image processing model, and limit computational resources allocated to transcoding, storing, and distributing moderated content.

### 1.2.1 Moderated Content Detection

Generally, the computer system can execute Blocks of the method S100 to serve the representative image to an external image processing model executing artificial intelligence and computer vision techniques to detect copyrighted, explicit, violent, or illegal content and/or content that otherwise violates terms of service for the video player.

In one example, the computer system can serve the representative image to an image processing model with a prompt to: implement optical character recognition to detect logos, icons, company names, or other brand text in the representative image; and return content to the computer system. The computer system can then automatically validate the mezzanine segment if these logos, icons, company names, or other brand text are associated with the publisher or origin of the video file; and vice versa.

Additionally or alternatively, the computer system can: pass the representative image to the image processing model with a prompt to implement artificial intelligence, template matching, or other computer vision techniques to detect specific moderated objects within the representative image, such as nudity, blood, weapons, and/or displays of violence, etc. ; and receive a list (or “tags”) of such moderated objects detected in the representative image from the image processing model. The computer system can then: automatically validate the mezzanine segment in response to the list received from the image processing model, excluding such moderated content indicators; and/or automatically invalidate the video file in response to the list received from the image processing model, including such moderated content indicators.

Additionally or alternatively, the computer system can: serve the representative image to the image processing model with a prompt to implement artificial intelligence and a large language model to generate a natural language description of the representative image (e.g., “The frame depicts an amateur football game. The image depicts sparsely-populated bleachers” or “The frame appears to depict nudity. Two people are present in the scene.”); and receive the natural language description generated by the image processing model. The computer system can then: automatically validate the mezzanine segment in response to the natural language description, excluding language signals indicated as moderated content; or automatically cease transcoding of the video file and disable distribution of rendition segments of the video file in response to the natural language description, including language signals indicating moderated content.

### 1.2.2 Just-In-Time Moderation

In one implementation, the computer system can execute verification of a particular video file in response to receiving a playback request for that video file from a user. In this implementation, prior to serving the video file to the user and concurrently with transcoding the mezzanine segment of the video file to a requested rendition segment, the computer system can transcode a segment of the video file into a representative image, serve this representative image to the image processing model, and receive confirmation of absence of moderated content within this image frame.

In particular, the computer system can: simultaneously transcode a mezzanine segment into a rendition segment of the video file based on the playback request; and, in response to receiving confirmation of absence of moderated content, serve the rendition segment to the user. Additionally or alternatively, in response to receiving confirmation of presence of moderated content within the representative image, the computer system can: cease transcoding of the rendition segment; delete a manifest associated with the video file; and remove the video file from the video player and an associated server (e.g., content distribution network). Therefore, the computer system can verify video files uploaded onto an audio-video platform prior to streaming these videos to a particular user with minimal latency between playback request and playback streaming.

### 1.2.3 Moderation Escalation

In one variation, the computer system can receive a confidence score from the image processing model representing confidence in presence of moderated content in a particular video file. In response to this confidence score falling below a threshold confidence score, the computer system can increase frame extraction frequency and/or resolution of representative images fed to the image processing model from the video file. In particular, in response to receiving a confidence score and a confirmation of presence of moderated content within the representative image from the image processing model, the confidence score falling below the threshold confidence score, the computer system can: transcode a second representative image (and/or set of representative images) in a second resolution greater than a first resolution of the first representative image; and serve the second representative image to the image processing model with the prompt to scan the second representative image for moderated content.

Therefore, in this variation, the computer system can: dynamically increase a rate of frame extraction and/or resolution of representative images associated with the video and served to the image processing model for detection of moderated content responsive to increased confidence of moderated content contained in previously presented representative images associated with the video file.

The method is described herein as executed by a remote computer system for video files. However, the remote computer system can execute Blocks of the method S200 for any media file, such as video files, audio files, image files, text files, etc.

The method is described herein as executed by a remote computer system (e.g., a remote server, hereinafter a “computer system”). However, Blocks of the method S100 can be executed by one or more entities accessing the network, by a local computer system, or by any other computer system-hereinafter a “system.”

### 1.3 Terms

Generally, the term “segment,” refers to a series of encoded audio and/or encoded video data spanning a discrete time interval, such as a consecutive series of frames in a video file or AV stream (hereinafter the “video file ”)

Generally, the term “mezzanine,” refers to a compressed master video file that supports transcoding in additional compressed video streams and video files (or “renditions,” downloads). For example, a mezzanine can include a highest-quality (e.g., highest bitrate and highest resolution) encoding (i.e., a bitrate resolution pair) of a video file cached by the computer system and derived from an original version of the video file uploaded to the computer system. In this example, a “mezzanine segment” can refer to a segment of a video file encoded at a highest-quality encoding for the video file.

Generally, the term “rendition” refers to an encoding of a video file indicated in a rendition manifest or manifest file (e.g., an HLS manifest) for a stream of the video file. Therefore, a “rendition segment” refers to a segment of the video file transcoded at a bitrate and/or resolution different from a corresponding mezzanine segment. The computer system can transcode a mezzanine segment into multiple corresponding rendition segments in various renditions representing the same time interval in the video file at differing bitrates and resolutions.

Generally, the computer system can interface directly with a video player (e.g., a video player) instance on a local computing device. Alternatively, the computer system can serve a stream of the video file to a content delivery network (hereinafter “CDN”), which can relay the stream of the video file to the video player instance. For ease of explanation, any discussion herein of requests by a video player or a video player instance are also applicable to requests by CDNs.

### 1.4 Video Ingest and Mezzanine

Generally, the computer system can: access a video file including a set of mezzanine segments.

In particular, the computer system can segment an ingested video file into a series of mezzanine segments. Upon ingest (e.g., upload, retrieval) of a raw video file, the computer system transcodes the raw video into a mezzanine video file. Following ingest, a first worker: segments the mezzanine into mezzanine segments, such as based on keyframes and minimum and maximum segment durations (e.g., between two and five seconds; between two and ten seconds); and stores these mezzanine segments in a rendition cache associated with the video file.

In one implementation, the computer system can: segment the video file into the series of mezzanine segments, each mezzanine segment in the series of mezzanine segments corresponding to a playback segment of the video file in a mezzanine format; and store the series of mezzanine segments in a rendition cache associated with the video file and the video player. Therefore, the computer system can prepare the video (e.g., video file, video stream) for parallel transcoding by separating the video file into the series of segments in mezzanine format (e.g., mezzanine segments) where each segment corresponds to a playback segment of the video. The computer system concurrently: retrieves transcoding parameters for an output rendition of the video file, such as target bitrate, resolution, frame rate, codec, container, and/or a variable or constant bitrate setting, etc.

### 1.5 Moderated Content Detection

Generally, in response to receiving a playback request for a particular video file, the computer system can: concurrently transcode a mezzanine segment into a rendition segment of the video file and a representative image of the mezzanine segment; and serve the representative image to an image processing model for confirmation (or rejection) of presence of moderated content.

In particular, in response to receiving a first request, at a first time, for a first rendition segment of the video file in a first rendition from a first video player, the computer system can: initiate transcoding of a first mezzanine segment, in the set of mezzanine segments, into the first rendition segment in the first rendition (e.g., at a first worker); and enable distribution of the first rendition segment to the video player.

Concurrent to transcoding of the first mezzanine segment into the first rendition segment, the computer system can: extract a first frame, in a first resolution, from the video file; convert the first frame into a first representative image in a second resolution less than the first resolution; and serve the first representative image to an image processing model for detection of moderated content in the first representative image.

Then, in response to the image processing model returning detection of moderated content in the first representative image, the computer system can: disable transcoding of the set of mezzanine segments into rendition segments in the first rendition; and disable distribution of rendition segments in the first rendition of the video file.

Additionally or alternatively, in response to the image processing model returning absence of detection of moderated content in the first representative image, the computer system can: maintain transcoding of the set of mezzanine segments into rendition segments in the first rendition; and enable distribution of rendition segments in the first rendition of the video file.

Additionally or alternatively, the computer system can implement methods and techniques as described herein to serve a particular representative image, for a video file, to the image processing model for detection of moderated content in the particular representative image at any other time, such as upon ingest of the video file.

### 1.5.1 Frame Selection

Generally, the computer system can extract a particular frame from the video file. In particular, the computer system can: select a particular frame from the first video file based on video characteristics of the first video file; and extract the particular frame from the video file for compression into a representative image, as further described below.

In one implementation, the computer system can pseudorandomly select the first frame of the video file. For example, the computer system can: pseudorandomly select a mezzanine segment in the set of mezzanine segments; and pseudorandomly extract the first frame from the first mezzanine segment. Additionally or alternatively, the computer system can select a frame from each mezzanine segment in the set of mezzanine segments.

In another implementation, the computer system can: detect a set of scenes within the first video file; select a first scene in the set of scenes; and extract a first frame from the first scene. In particular, the computer system can: detect subsets of frames representing scenes (e.g., based on clusters of semantically-related segments) in the video file; and, for each scene, extract a frame from the scene (e.g., a start of the scene, a middle of the scene, an end of the scene). For example, the computer system can: detect a first scene represented by a contiguous series of frames in the video file; select a first frame (e.g., an initial frame) proximal a beginning of the contiguous series of frames; select a second frame proximal a middle of the contiguous series of frames (e.g., pseudo-randomly selected from the contiguous series of frames); and/or select a third frame (e.g., a terminal frame) proximal a temporal end of the contiguous series of frames.

Similarly, the computer system can: define a first shot boundary, represented by a continuous series of frames in the video file, the continuous series of frames representing a single camera take; and (pseudorandomly) select a subset of frames from the continuous series of frames. For example, the computer system can define a first shot boundary based on temporal discontinuities or transitions between consecutive frames, and/or based on detecting (abrupt) transitions in frame-to-frame visual features (e.g., color histograms, edge maps, motion vectors, deep feature embeddings). The computer system can then: define a set of shots within the video file; and extract a frame from each shot in the set of shots. Additionally or alternatively, the computer system can: define a set of shots within the video file; select a first shot in the set of shots; and extract a frame from the first shot.

In another implementation, the computer system can extract the first frame and a second frame, in the first resolution, from the video file according to a first frame extraction frequency. For example, the computer system can extract the first frame and a second frame, in the first resolution, from the video file according to a first frame extraction frequency proportional to a complexity (e.g., motion, pixel diversity, temporal entropy, edge density, color histogram variance, bitrate variability, iframe frequency, macroblock variance) of the video.

Additionally or alternatively, the computer system can: for a first video file, derive a first set of motion characteristics (e.g., motion vectors) from the first video file; calculate a first motion metric representing complexity of the video file based on the first set of motion characteristics; and extract the first frame based on the first motion metric.

For example, for a first mezzanine segment in the set of mezzanine segments, the computer system can: select a first frame; and characterize a first motion artifact value representing visual artifacts indicative of motion, for the first frame. In response to the first motion artifact value exceeding a threshold motion artifact value, the computer system can: select a second frame temporally succeeding the first frame; and characterize a second motion artifact value for the second frame. In response to the second motion artifact value exceeding the threshold motion artifact value, the computer system can: select a third frame, temporally succeeding the second frame; characterize a third motion artifact value of the third frame; and, in response to the third motion artifact value falling below the threshold motion artifact value, extract the third frame in the first resolution from the video file.

Therefore, in the foregoing example, the computer system can select a frame, in a consecutive series of frames, that exhibits low motion artifacts (e.g., blur, object blur) to enable the model to identify objects and derive tags representing content in the frame based on the representative image derived from the frame.

Additionally or alternatively, the computer system can: for a first video file, derive a first set of motion characteristics (e.g., motion vectors) from the first video file; calculate a first motion metric representing complexity of the video file based on the first set of motion characteristics; and access a first frame extraction frequency proportional to the first motion metric.

In particular, in this example, the computer system can: extract a first frame from a first video file according to a first frame extraction frequency; and extract a second frame and a third frame, in the first resolution, from a second video file according to a second frame extraction frequency exceeding the first frame extraction frequency, such as in response to the second video file exhibiting a second complexity greater than a first complexity of the first video file.

Additionally or alternatively, the computer system can: for a first video file, derive a first set of motion characteristics (e.g., motion vectors) from the first video file; calculate a first motion metric representing complexity of the video file based on the first set of motion characteristics; and access a first frame extraction frequency proportional to the first motion metric.

Therefore, the computer system can selectively extract frames from the video file based on characteristics of the video file to thereby reduce computational resources of representative image generation (e.g., compression), as further described herein. Additionally, the computer system can minimize a count of frames extracted from the video file to limit contextual information provided to the image processing model, as further described herein, to thereby limit computational resources utilized by the image processing model.

### 1.5.2 Representative Image Compression

Generally, the computer system can compress a particular frame, extracted from a particular video file, into a representative image representing content present in the video file. In particular, the computer system converts the particular frame, from a first resolution into a second resolution less than the first resolution, prior to serving the representative image to an image processing model for detection of moderated content, as further described herein.

In one example, the computer system can: extract a first frame and a second frame from the video file; and compress the first frame and the second frame into the first representative image in the second resolution.

Additionally or alternatively, the computer system can compile multiple frames into a single representative image (e.g., a “storyboard,” a grid, tiles) defined by a lower resolution than each individual frame. For example, the computer system can generate the representative image as a composite image including a set of frames arranged in a fixed spatial layout. For example, the computer system can: arrange a first frame and a second frame in adjacent regions of a two-by-one grid; and downsample the grid to generate the representative image.

In another variation, the computer system generates the representative image as an animated image (e.g., “gif”) derived from multiple frames and defined by the second resolution. For example, the computer system can encode the first frame and the second frame as a two-frame animated image with a fixed playback interval and a fixed pixel dimension corresponding to the second resolution.

Generally, the computer system can transcode a representative image of the video file, such as in response to receiving a request for a playback segment of the video file by a particular user device. The computer system can then pass this representative image to an image processing model with a prompt to investigate the representative image and return characteristics of this representative image.

For example, the computer system can: access an iframe (e.g., keyframe) of a video file, such as identified in a particular mezzanine and/or playback segment of the video file; and transcode this iframe into a representative image of a (low) resolution and a (low) bitrate for transmittal to an image processing model.

### 1.5.3 Representative Image Processing

In one implementation, the computer system can serve the representative image to the image processing model with a prompt to confirm if the representative image aligns with a terms of service and/or terms and conditions agreement associated with the video player and/or a streaming platform associated with the video player.

In response to receiving confirmation of content that violates the terms of service present in the representative image, the computer system: ceases streaming of the playback segment; disables transcoding of mezzanine segments associated with the video file; and/or deletes a manifest associated with the video file to prevent streaming of the video file.

In particular, the computer system can pass the representative image to the image processing model with a prompt to scan the representative image for violent content, inappropriate (e.g., nude) content, and/or other content types that violate the terms and conditions for the video player and/or the streaming platform.

### 1.5.4 Copyright Indicators

In a similar implementation, the computer system can, upon ingest of a video file: transcode a representative image of this video file; pass the representative image of the video file to an image processing model with a prompt to scan the representative image for copyrighted content; and, in response to receiving confirmation of presence of copyrighted content (e.g., an illegal live-stream of a concert, illegal use of a music video) implement methods and techniques as described herein to remove the video file from the video player and/or the streaming platform.

In one example, the computer system can prompt the image processing model to detect a text block in the representative image, wherein the text block indicates copyright material (e.g., logos, particular fonts, text indicating username from sourced application). Additionally or alternatively, the computer system can prompt the image processing model to detect an icon in the representative image. The computer system can then: receive the icon from the image processing model; and match the icon to an icon database including icons (or “brand identifiers”) associated with a set of brands. In particular, the computer system can: calculate a match score for the icon detected in the representative image and a brand identifier from the icon database; and, in response to this match score exceeding a threshold score, confirm association between the icon and the brand identifier. The computer system can then verify the video file by: identifying the publisher of the video file; and, in response to a second match score between the publisher of the video file and the brand associated with the brand identifier exceeding a second threshold match score, confirm verification of the video file. Additionally or alternatively, in response to the second match score falling below the second match score threshold, the computer system can: confirm presence of moderated content based on the publisher uploading a video file representing branded content not belonging to the publisher; and remove the video file from the video player and/or the streaming platform.

In one variation, the computer system can prompt the image processing model to detect specific copyright indicators such as: “©,” “all rights reserved,” “copyright,” “work,” “performance,” “broadcast,” etc. The computer system can then receive confirmation of copyrighted content from the image processing model based on presence of a copyright indicator, and automatically remove the video file from the video player and/or the streaming platform.

### 1.5.5 Explicit Content

In a similar implementation, the computer system can, upon ingest of a video file: transcode a representative image of the video file; pass the representative image of the video file to an image processing model with a prompt to scan the representative image for explicit content; and, in response to receiving confirmation of presence of explicit content (e.g., violent content, sexual content) implement methods and techniques as described herein to remove the video file from the video player and/or the streaming platform.

More specifically, the computer system can prompt the image processing model to scan the representative image for violent content, such as presence of blood and/or graphic wounds, distorted human figures, weapons, and/or violence-related text (e.g., “kill,” “harm”). In response to receiving confirmation from the image processing model of violent content present in the representative image, the computer system can cease transcoding of the video file and/or remove the video file from the video player and/or the streaming platform associated with the video player.

Similarly, the computer system can prompt the image processing model to scan the representative image for sexual content, such as presence of naked human bodies (e.g., over a threshold of skin percentage showing), poses suggesting explicit (and/or sexual) behavior, and/or sexually-suggestive text. In response to receiving confirmation from the image processing model of sexual content present in the representative image, the computer system can cease transcoding of the video file and/or remove the video file from the video player and/or the streaming platform.

### 1.5.6 Terms of Service Violations

In yet another implementation, the computer system can: access a terms of service agreement for a video player (and/or an associated server); extract a set of blacklisted concepts representing concepts that are explicitly banned from being uploaded onto and/or streamed from the video player and the associated server from the terms of service agreement; and store the set of blacklisted concepts.

For example, the computer system can: access a policy document defining restricted content for the video player in Block S170; generate a prompt to generate a moderation score representing compliance with the policy document; and serve the first representative image, the policy document, and the prompt to the image processing model for detection of moderated content in the first representative image based on restricted content defined by the policy document. In this example, the computer system can disable transcoding of the set of mezzanine segments into rendition segments in the first rendition in response to the moderation score, returned by the image processing model, falling below a threshold moderation score and thereby indicating presence of moderated content.

Additionally or alternatively, the computer system can access a policy document defining permissible content for the video player. For example, the computer system can: access a policy document defining permissible (e.g., allowed) content for the video player; and serve the first representative image and the policy document to the image processing model for detection of moderated content in the first representative image based on permissible content defined by the policy document.

In one variation, the computer system can parse the policy document prior to serving the policy document to the image processing model. For example, the computer system can: extract a set of blacklisted concepts from the policy document; and serve the set of blacklisted concepts to the image processing model in place of the policy document. In another example, the computer system can identify sections (e.g., paragraphs, pages) of the policy document corresponding to restricted content and serve only these sections of the policy document to the image processing model. Accordingly, the computer system can serve lower-resolution data to the image processing model for detection of moderated content by the image processing model, to thereby reduce computational resources allocated to the image processing model.

In one implementation, the computer system can implement methods and techniques as described herein to detect moderated content prior to initiating transcoding of the video file or during just-in-time transcoding of the video file in response to a request to stream the video file. For example, in response to receiving a request to stream a particular video file, the computer system can: transcode a representative image for the particular video file; and serve the representative image to the image processing model with a prompt to detect blacklisted concepts in the set of blacklisted concepts.

In response to receiving a request to stream a video file, the computer system can: transcode a representative image of the video file; and serve the representative image to the image processing model with a prompt to scan the representative image for blacklisted concepts in the set of blacklisted concepts if the representative image. In response to receiving confirmation from the image processing model of presence of a blacklisted concept, in the set of blacklisted concepts, the computer system can: confirm that the video file violates the terms of service agreement; cease transcoding of the video file; remove the video file from the streaming platform; and/or remove a publisher, associated with the video file, from the streaming platform.

Therefore, the computer system can constrain moderated content detection to policy-defined concepts by selectively serving policy-derived data (e.g., text) to the image processing model to thereby limit computational resources expended by the image processing model while ensuring detection of terms of service violations during streaming and transcoding operations.

### 1.6 Video Publication Controls

Generally, the computer system can implement methods and techniques as described herein to concurrently transcode a video file into a mezzanine segment and a representative image of the video file. The computer system can then pass the representative image to the image processing model with a prompt to scan the representative image for moderated content. In response to the image processing model failing to detect moderated content in the representative image, the computer system can: continue to transcode the video file into mezzanine segments and concurrently transcode representative images for each mezzanine segment in a set of mezzanine segments associated with the video file; and distribute the mezzanine segment (or any other rendition segment transcoded from this mezzanine segment) of the video file to users via the video player. The computer system can then continuously pass representative images to the image processing model for each representative image in the set of representative images associated with the set of mezzanine segments.

Additionally or alternatively, in response to receiving confirmation of moderated content present in a video file, the computer system can: cease transcoding of the video file; cease distribution (e.g., streaming) of the video file; remove the video file from the streaming platform; and/or remove a publisher, associated with the video file, from the streaming platform.

In particular, the computer system can implement methods and techniques as described herein to concurrently transcode a video file into a set of mezzanine segments and a set of representative images of the video file. In response to the image processing model detecting presence of moderated content (e.g., violent content, sexually explicit content, content violating the terms of service agreement, copyrighted content) in a representative image in the set of representative images, the computer system can: cease transcoding of the mezzanine segments for the video file; cease distribution of the video file to users; remove the video file from the streaming platform; and/or remove the publisher associated with the video file from the streaming platform.

In one example, the computer system monitors frames of the video file, during transcoding of mezzanine segments into rendition segments, for detection of moderated content. In this example, the computer system: extracts a first frame from a first mezzanine segment; converts the first frame into a representative image; and serves the representative image to the image processing model for detection of moderated content. In response to the image processing model failing to detect moderated content in the representative image, the computer system maintains transcoding of the video file and distribution of rendition segments derived from the video file. In this example, the computer system then: extracts a second frame from a second mezzanine segment succeeding the first mezzanine segment; converts the second frame into a representative image; and serves the representative image to the image processing model for detection of moderated content. In response to the image processing model detecting moderated content in the representative image, the computer system ceases transcoding of mezzanine segments and disables distribution of rendition segments of the video file.

In particular, in this example, in response to receiving a request, at a first time, for a first rendition segment of the video file in the first rendition from the first video player, the computer system can: initiate transcoding of a first mezzanine segment, in the set of mezzanine segments, into a first rendition segment in the first rendition; enable distribution of the first rendition segment to the video player; extract a first frame, in a first resolution, from the video file; convert the first frame into a first representative image in a second resolution less than the first resolution; serve the first representative image to an image processing model for detection of moderated content in the first representative image; and, in response to the image processing model failing to detect presence of moderated content in the first representative image, maintaining transcoding of the set of mezzanine segments into rendition segments in the first rendition.

Accordingly, in response to the image processing model failing to detect presence of moderated content in the first representative image, the computer system can initiate transcoding of a second mezzanine segment, in the set of mezzanine segments, into a second rendition segment in the first rendition.

In particular, in response to receiving a second request, at a second time following the first time, for a second rendition segment of the video file in the first rendition, the computer system can: initiate transcoding of a second mezzanine segment, in the set of mezzanine segments and succeeding the first mezzanine segment, into the second rendition segment in the first rendition; enable distribution of the second rendition segment to the video player; extract a second frame, in the first resolution, from the video file; convert the second frame into a second representative image the second resolution; serve the second representative image to the image processing model for detection of moderated content in the second representative image; and, in response to the image processing model detecting presence of moderated content in the first representative image, disable transcoding of the set of mezzanine segments into rendition segments in the first rendition. In particular, in response to the image processing model returning detection of moderated content in the first representative image, the computer system can: disable transcoding of the second mezzanine segment, in the set of mezzanine segments, into a second rendition segment in the first rendition; and disable distribution of the first rendition segment and the second rendition segment to the video player.

Accordingly, the computer system can disable distribution in response to detecting moderated content in a subsequent representative image.

Therefore, the computer system can control continuation of transcoding and distribution of a video file on a segment-by-segment basis by evaluating representative images extracted during transcoding to thereby prevent distribution of moderated content while limiting transcoding and streaming operations to video segments that satisfy moderation constraints.

### 1.6.1 Closed-Loop Moderation

In one implementation, the computer system can receive a confidence score from the image processing model, the confidence score representing confidence in presence of copyrighted content within the representative image of a first resolution and a first bitrate. In response to this confidence score falling below a threshold score, the computer system can increase a time interval over which extraction (and/or transcoding) of representative images occurs (e.g., extract more frames per unit time). Additionally or alternatively, in response to this confidence score falling below the threshold confidence score, the computer system can increase resolution of the representative image.

In one example, the computer system can receive confirmation of presence of copyrighted content within a particular video file and an associated confidence score (e.g., 5) from the image processing model. In response to the associated confidence score falling below a threshold confidence score (e.g., 7, 7.5) the computer system can extract a second representative image from the playback segment, the second representative image of a second resolution greater than the first resolution and a second bitrate greater than the first bitrate.

Therefore, the computer system can verify, with at least a threshold confidence, that the image processing model correctly identified moderated content within a particular video file and, in response to a confidence score falling below this threshold confidence, iteratively serve the image processing model with a set of representative images to increase confidence in presence or absence of moderated content.

### 1.6.2 Moderation Analysis Escalation

In one variation, the computer system can repeat methods and techniques as described herein in response to the image processing model returning a confidence score—representing confidence in detection of moderated content—falling below a threshold confidence score.

In one example, the computer system can increase a resolution of the representative image in response to the image processing model returning a confidence score—representing confidence in detection of moderated content—falling below a threshold confidence score.

In particular, in response to receiving a second request, at a second time preceding the first time, for a second rendition segment of the video file in the first rendition from the first video player, the computer system can: initiate transcoding of a second mezzanine segment, in the set of mezzanine segments and preceding the first mezzanine segment, into the second rendition segment in the first rendition; enable distribution of the second rendition segment to the video player; extract a second frame, in a third resolution less than the first resolution, from the video file; convert the second frame into a second representative image in a fourth resolution less than the third resolution; serve the second representative image to the image processing model for detection of moderated content in the second representative image; receive detection of moderated content in the second representative image from the image processing model in Block S142; receive a first confidence score from the image processing model, the first confidence score representing confidence of detection of moderated content in the second representative image in Block S146; and, in response to the first confidence score falling below a threshold confidence score, maintain transcoding of the set of mezzanine segments into rendition segments in the first rendition.

For the first time succeeding the second time, the computer system can: convert the first frame into the first representative image in the second resolution less than the first resolution and greater than the fourth resolution; receive a second confidence score from the image processing model, the second confidence score representing confidence of detection of moderated content in the first representative image; and, in response to the second confidence score exceeding the threshold confidence score, disable transcoding of the set of mezzanine segments into rendition segments in the first rendition.

In another example, the computer system can increase a count of frames extracted from the video file, for generation of the representative image, in response to the image processing model returning a confidence score—representing confidence in detection of moderated content—falling below a threshold confidence score.

In particular, for the first time succeeding the second time and responsive to the first confidence score falling below the threshold confidence score, the computer system can: extract a first frame and a second frame, in the first resolution, from the video file; compress the first frame and the second frame into the first representative image in the second resolution; receive a second confidence score from the image processing model, the second confidence score representing confidence in detection of moderated content in the first representative image; and, in response to the second confidence score exceeding the threshold confidence score, disable transcoding of the set of mezzanine segments into rendition segments in the first rendition.

In particular, in this example, the computer system can: extract a first frame and from a first video file, during the second time, according to a first frame extraction frequency; and, for the first time succeeding the second time, extract a second frame and a third frame, in the first resolution, from the video file according to a second frame extraction frequency exceeding the first frame extraction frequency in response to the first confidence score falling below the threshold confidence score.

Therefore, the computer system can: dynamically increase a resolution and/or frequency of representative images derived from the video and served to the image processing model for detection of moderated content responsive to a) increases in confidence scores of moderated content contained in previously processed representative images extracted from the video file and/or b) increases in uncertainty of content contained in these previously processed representative images.

### 1.6.3 Content Minimization

Additionally or alternatively, the computer system can reduce content served to the image processing model responsive to a confidence score, representing confidence in detection of moderated content, exceeding a threshold confidence score. In particular, in response to a first confidence score for a first rendition segment exceeding a threshold confidence score, for a second rendition segment succeeding the first rendition segment, the computer system can: implement methods and techniques as described herein to extract a second frame from a second mezzanine segments corresponding to the second rendition segment; and convert the second frame into a second representative image of a third resolution, less than the second resolution.

For example, the computer system can: receive a first confidence score from the image processing model, the first confidence score representing confidence of failure to detect moderated content in the second representative image; and initiate transcoding of the first mezzanine segment, in the set of mezzanine segments, into the first rendition segment in the first rendition in response to the confidence score exceeding a threshold confidence score.

At a second time succeeding the first time, for a second mezzanine segment in the set of mezzanine segments, the computer system can: extract a second frame in the first resolution from the second mezzanine segment; convert the second frame into a second representative image in a third resolution less than the second resolution; serve the second representative image to the image processing model for detection of moderated content in the second representative image; and, in response to the image processing model returning detection of moderated content in the first representative image, disable transcoding of the second mezzanine segment, in the set of mezzanine segments, into a second rendition segment in the first rendition and disable distribution of the first rendition segment and the second rendition segment to the video player.

In another example, during a first time period, the computer system can implement methods and techniques as described herein to generate a first representative image based on a set of (e.g., two) frames extracted from the first video file. Then, in response to a confidence score associated with the representative image exceeding a threshold confidence score, the computer system can generate a second representative image based on a single frame extracted from the first video file.

Therefore, the computer system can reduce content served to the image processing model in response to confidence scores exceeding a threshold confidence score (e.g., by greater than a threshold amount) to thereby limit a size of prompts provided to the image processing model while maintaining moderated content detection confidence within a predefined confidence range (e.g., 70 percent, 80 percent, 90 percent). Furthermore, the computer system can minimize computational resources allocated to the image processing model for moderated content detection by adaptively constraining representative image resolution and frame count.

### 1.7 Variation: Audio Extraction+Transcript

The method is described herein as executed by a computer system to serve representative images to an image processing model to detect visually moderated content. Additionally or alternatively, the computer system can implement methods and techniques as described herein to: serve an audio file associated with the video file to a model (e.g., an audio detection model, the image processing model) with a prompt to scan the audio file for moderated content; and, in response to receiving confirmation of moderated content present in the audio file, cease playback of the video file.

In particular, the computer system can: access an audio file, characterized by a first file size, associated with the video file in Block S160; select a segment of the audio file corresponding to the first frame in Block S162; and compress the segment of the audio file into a representative audio file. The computer system can then serve the representative audio file to the model for detection of moderated content.

For example, the computer system can: access an audio file, defined by a first bitrate, associated with the video file; extract a five-second audio segment aligned to a timestamp of the first frame; and compress the audio segment from a second bitrate, less than the first bitrate, to generate a representative audio file. The computer system can then: serve the representative audio file to the model with a prompt to detect moderated content (e.g., copyrighted music) present in the representative audio file. In response to the model returning detection of moderated content in the representative audio file, the computer system can cease playback of the video file.

In one implementation, the computer system can segment a video file into a set of audio segments, each audio segment in the set of audio segments including a portion of an audio stream of the video file. The computer system can then, in response to receiving a first request for a playback segment of the video file in a first rendition from an video player: pass an audio segment, from the set of audio segments, to an audio detection model with a prompt to scan the audio segment for moderated content. The computer system can then, in response to the audio detection model returning confirmation of moderated content present in the audio stream: close the video file; deactivate the manifest; and cease transcoding of the set of audio (and/or mezzanine) segments.

In another variation, the computer system can pass both the representative image and an associated audio segment to a detection model with a prompt to scan for moderated content. The computer system can then, in response to receiving confirmation of such content, remove the video file from the video player and/or the streaming platform.

In a similar implementation, the computer system can implement methods and techniques as described herein to generate a transcript based on the audio file.

For example, the computer system can: access an audio file, characterized by a first file size, associated with the video file in Block S160; select a segment of the audio file corresponding to the first frame in Block S162; and generate a transcript based on the audio file, the transcript characterized by a second file size less than the first file size in Block S164. The computer system can then: serve the first representative image and the transcript to the image processing model for detection of moderated content in the first representative image.

Additionally or alternatively, the computer system can: access a transcript of an audio stream associated with the first video file; extract a transcript segment, temporally intersecting the first frame, from the transcript of the audio stream; and serve the first representative image and the transcript segment to the image processing model for detection of moderated content in the first representative image.

Accordingly, the computer system can compress an audio file and/or compress a transcript—exhibiting smaller file size than the audio file—and serve to the image processing model for detection of moderated content.

Therefore, in this variation, the computer system can augment visual detection of copyrighted content with an audio stream to increase confidence and/or likelihood of detection of moderated content within a particular video file.

### 1.8 Variation: Preemptive Moderation

In one variation, the computer system transcodes a representative image of a particular video file in response to ingesting the video file and prior to receiving a stream request for this video file. In particular, the computer system can: receive a video file, such as uploaded by a user onto a video player; in response to receiving the video file, transcode a first mezzanine segment, including a portion of the video file, at a first worker; initiate transcoding of a representative image by a second worker; and serve the representative image from the first worker to the image processing model with a prompt to scan the representative image for moderated content. The computer system can then, in response to receiving confirmation of moderated content present in the representative image: cease transcoding of mezzanine segments; and/or remove a manifest, associated with the video file, from the streaming platform to prevent streaming (or requesting) of the video file.

For example, in this variation, the computer system can access a video file including a set of mezzanine segments and, at a first time, for a first mezzanine segment in the set of mezzanine segments: extract a first frame in a first resolution from the first mezzanine segment; convert the first frame into a first representative image in a second resolution less than the first resolution; and serve the first representative image to an image processing model for detection of moderated content in the first representative image. In response to the image processing model returning failure to detect moderated content in the first representative image, the computer system can: initiate transcoding of the first mezzanine segment, in the set of mezzanine segments, into a first rendition segment in a first rendition; and enable distribution of the first rendition segment to a video player.

In this implementation, the computer system can complete moderated content detection prior to enabling publication of the video file. For example, in response to ingesting the video file, the computer system can: extract a representative image from a first mezzanine segment; serve the representative image to the image processing model for detection of moderated content; and, in response to the image processing model returning failure to detect moderated content, generate and store a manifest associated with the video file to permit subsequent streaming of the video file.

In a similar implementation, the computer system can repeat methods and techniques as described herein for moderated content detection in response to receiving a request to stream the video file after ingest of the video file. For example, after generating the manifest associated with the video file at ingest and in response to receiving a request to stream the video file, the computer system can: extract a representative image from a mezzanine segment corresponding to the request; serve the representative image to the image processing model for detection of moderated content; and, in response to the image processing model returning detection of moderated content, remove the manifest associated with the video file to prevent further streaming of the video file.

In particular, upon ingest of the video file during a second time preceding the first time, the computer system can: extract a first frame, in a first resolution, from the video file; convert the first frame into a first representative image in a second resolution less than the first resolution; serve the first representative image to an image processing model for detection of moderated content in the first representative image; and, in response to the image processing model failing to detect presence of moderated content in the first representative image, maintain transcoding of the set of mezzanine segments into rendition segments in the first rendition in Block S120. Specifically, the computer system can: receive failure to detect presence of moderated content in the first representative image from the image processing model in Block S144; and maintain transcoding of the set of mezzanine segments into rendition segments in the first rendition in Block S120.

Then, during a second time—such as in response to receiving a request for a particular rendition segment of the video file—in response to the image processing model failing to detect presence of moderated content in the first representative image, the computer system can initiate transcoding of the first mezzanine segment, in the set of mezzanine segments, into the first rendition segment in the first rendition.

Accordingly, the computer system can concurrently transcode mezzanine segments and verify absence of moderated content to allow a user to request and stream the verified video file. Therefore, in this variation, the computer system can proactively review content uploaded to the streaming platform and automatically remove moderated content prior to a streaming event for this content.

### 1.9 Codec Selection

In one variation, the computer system can pass the raw video file to an image processing model with a prompt to: detect a content type of the video file; and, based on the content type, derive a codec for transcoding the video file into a playback (and/or mezzanine) segment.

For example, the computer system can ingest a particular video file representing a calm ocean scene. In this example, the image processing model can detect that content in the video file represents the calm ocean scene and recommend a particular codec (e.g., H.264m AV1) associated with low-motion content and an increased frame gap between iframes. The computer system can then ingest a second video file representing an action scene. The computer system can then pass this second video file to the image processing model, which can detect that content in the second video file represents an action scene and recommend a different (or the same) codec (e.g., H.265, AV₁, VP₉) associated with a higher bitrate and reduced frame gap between iframes.

Therefore, the computer system can leverage the image processing model to efficiently compress and/or transcode the video file into mezzanine segments and/or other playback segments without increasing lag for streaming of a particular playback segment.

### 1.10 Variation: Overlay Generation+Rendering

Generally, the computer system can pass a representative image for a video file to an image processing model with a prompt to return a content type and/or identify video characteristics of the video file based on the representative image. Then, in response to receiving the content type, the computer system can: generate a chyron (e.g., an overlay, an icon) of the content type; and append the video file with the chyron.

In one implementation, the computer system can receive identification of a content type for a particular livestream; generate an overlay and/or chyron for the livestream based on the content type; and render the overlay on a cover image of the livestream.

In one example the computer system can: receive identification of a scoreboard in the representative image, from the image processing model; generate a prompt requesting extraction of a score from the scoreboard according to an extraction frequency (e.g., every minute) from the image processing model; and pass this prompt to the image processing model with a set of representative images (e.g., a proxy stream transcoded from a set of mezzanine segments).

The computer system can then: generate a representation of the score (e.g., chyron, icon, score display); and annotate the playback segment with the representation of the score, such as on a thumbnail of the playback segment and/or displayed alongside the playback segment at the video player.

In one implementation, the computer system can dynamically update the frame extraction rate based on changes and/or features of the video file.

In particular, in the foregoing example, the computer system can: detect an increase in amplitude (or volume) of an audio stream associated with the video file; based on the increase in amplitude, increase a frame extraction rate for generation of representative images to pass to the detection model to identify a change in score and/or identify a key event; and update the representation to represent the change in score. Additionally or alternatively, the computer system can generate a second representation, representing the key event, and temporarily render the second representation proximal the first representation.

The method is described herein as executed by a remote computer system to generate and render a chyron of a key feature, identified by an image processing model, of a particular video file. Additionally or alternatively, in response to receiving identification of the key feature from the image processing model, the computer system can: prompt a second model to generate a chyron (e.g., a thumbnail, an overlay, an icon) of the content type; and render the chyron, generated by the second model, on and/or near the video file during playback.

Therefore, the computer system can dynamically (and in near real-time) update this chyron such that a viewer may perceive real-time augmented content for this particular video file and/or video stream during playback.

### 1.11 Variation: Tags

In one implementation, the computer system can: request a set of tags, representing content in the representative image, from the image processing model; and receive confirmation of presence of moderated content based on the set of tags.

For example, the computer system can: serve the representative image to the image processing model with a prompt to generate tags representing content in the representative image; and receive a set of tags, generated by the image processing model. In one variation, the image processing model can scan the set of tags for presence of moderated content and return presence and/or absence of moderated content, in the representative image, to the computer system. Additionally or alternatively, the computer system can scan the set of tags for presence of moderated content. For example, the computer system can: serve the first representative image and a prompt to generate a set of tags representing content in the first representative image to the image processing model; and disable transcoding of the set of mezzanine segments into rendition segments in the first rendition in response to the image processing model returning detection of moderated content in the first representative image based on the set of tags.

Accordingly, in this variation, the computer system can close a particular video file in response to detection of moderated content in a set of tags associated with the particular video file.

Additionally or alternatively, in response to absence of detection of moderated content in a set of tags associated with the particular video file, the computer system can tag the particular video file with the set of tags.

In one implementation, the computer system can, in response to receiving a set of characteristics represented in a representative image: generate a tag for each characteristic in the set of characteristics; and append the video file with the tag.

In particular, the computer system can implement methods and techniques as described herein to pass a representative image for a video file to an image processing model with a prompt to return a content type and/or identify a set of video characteristics of the video file based on the representative image.

For example, the computer system can: pass a representative image (e.g., an ocean scene) for a video file to an image processing model with a prompt to identify a set of characteristics of the representative image; receive the set of characteristics (e.g., ocean, sandcastle, sunshine, beach) from the image processing model; generate a set of tags (e.g., waterfront, water, sand, sun, beach) based on the set of characteristics; and append the set of tags to the video file.

Additionally or alternatively, the computer system can: pass a representative image for a video file to an image processing model with a prompt to generate a set of tags based on a set of audio and/or visual characteristics of the representative image; and automatically append the set of tags to the video file.

Therefore, the computer system can automatically generate and/or access a set of tags based on visual and/or audio characteristics for a particular video file and annotate the video file with the set of tags, thereby increasing contextual cues for a viewer and/or assist a user in discovering the video file on the video player based on target content types.

### 2. Second Method

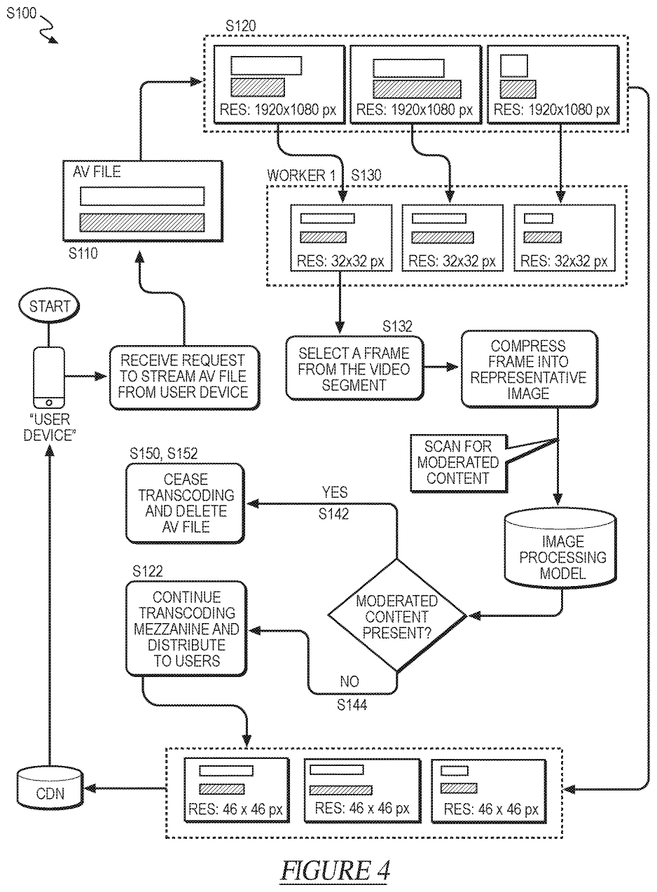

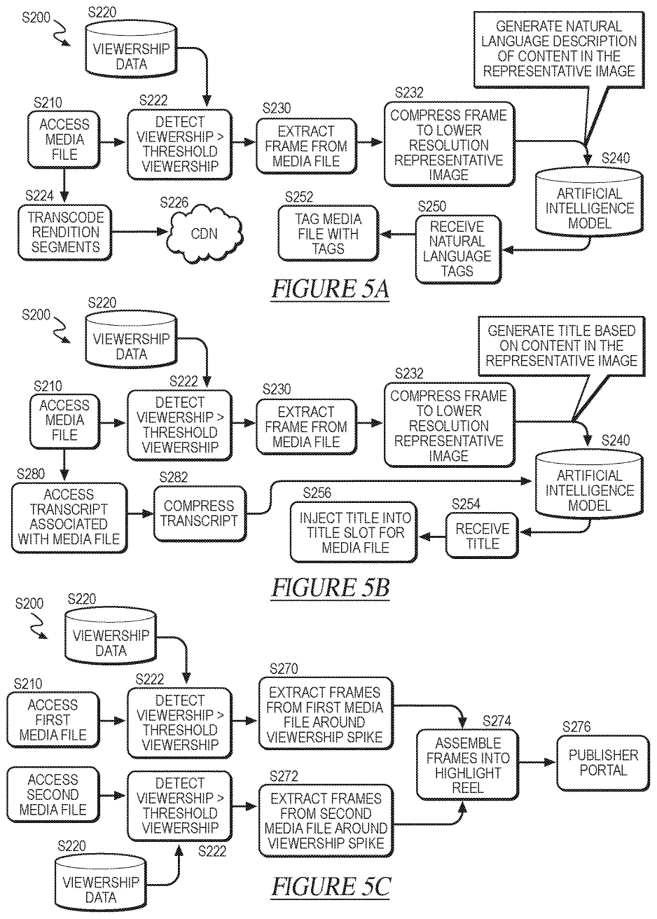

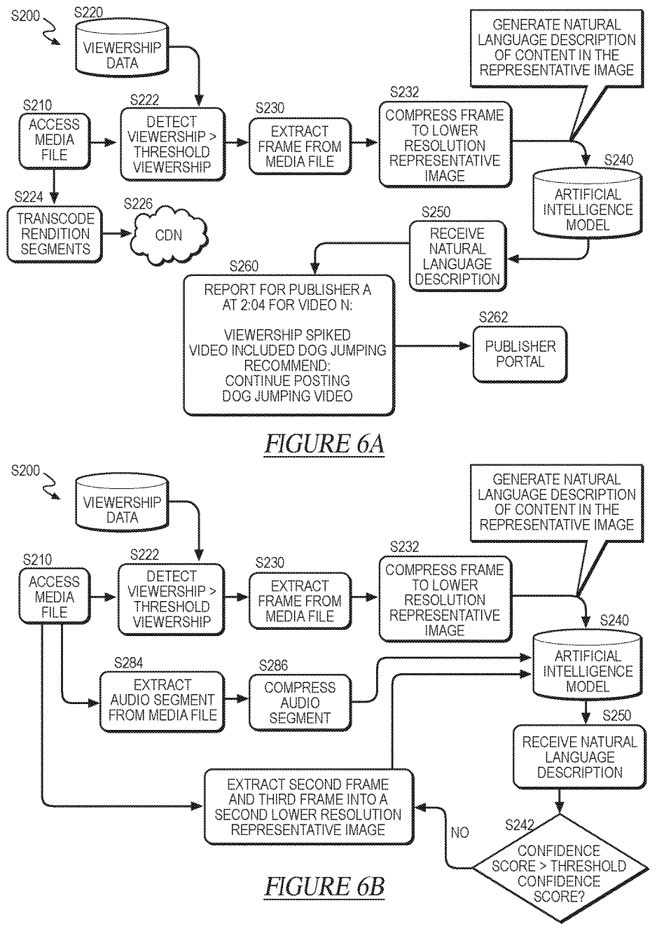

As shown in FIGS. 4-6B, a second method S200 includes: accessing a video file in Block S210; accessing a first set of viewership data for the video file in Block S220; detecting a first viewership data characteristic in the first set of viewership data for the video file in Block S222; extracting a first frame, in a first resolution, from the video file, the first frame corresponding to the first viewership data characteristic in Block S230; converting the first frame into a first representative image in a second resolution less than the first resolution in Block S232; serving the first representative image to a model for generation of tags representing content in the first representative image in Block S240; receiving a first set of tags from the model in Block S250; and tagging the video file with the first set of tags in Block S252.

### 2.1.1 Variation: Pre-Publishing Tags

In one variation, the second method S200 includes: accessing a video file including a set of mezzanine segments in Block S210; extracting a first frame in a first resolution from the video file in Block S230; converting the first frame into a first representative image in a second resolution less than the first resolution in Block S232; serving the first representative image to a model for generation of tags representing content in the first representative image in Block S240; receiving a first set of tags from the model in Block S250; and tagging the video file with the first set of tags in Block S252.

This variation of the method S200 also includes: initiating transcoding of each mezzanine segment, in the set of mezzanine segments, into a first rendition segment, in a set of rendition segments, in a first rendition in Block S224; and enabling distribution of the set of rendition segments to a video player in Block S226.

### 2.1.2 Variation: Tags+Frames+Scenes

In one variation, the second method S200 includes: accessing a video file in Block S210; extracting a first frame in a first resolution from the video file in Block S230; converting the first frame into a first representative image in a second resolution less than the first resolution in Block S232; serving the first representative image to a model for generation of tags representing content in the first representative image in Block S240; receiving a first set of tags, representing content within the first frame, from the model in Block S250; and tagging the video file with the set of tags in Block S252.

Additionally or alternatively, the method S200 includes tagging the first frame with the first set of tags.

Additionally or alternatively, the method S200 includes: detecting a contiguous series of frames, proximal the first frame, the contiguous series of frames representing a first scene; detecting a contiguous series of frames, containing the first frame, corresponding to a first scene in the video file; and tagging the contiguous series of frames—depicting the first scene—with the first set of tags.

### 2.1.3 Variation: Transcript +Multi-Tag Call

In one variation, the second method S200 includes: accessing a video file; accessing a transcript associated with the video file; selecting a first frame from the video file; and generating a prompt to generate natural language descriptions of a) content represented in the first frame, b) content represented in a first scene, including the first frame, based on the first frame and the transcript, and c) content represented in the video file based on the first frame and the transcript.

This variation of the second method S200 also includes: serving the first frame and the prompt to a model; receiving a first set of tags, representing content within the first frame, from the model; receiving a second set of tags, representing content within the first scene, from the model; and receiving a third set of tags, representing content within the video file, from the model.

This variation of the second method S200 further includes: tagging the first frame with the first set of tags; tagging a first set of frames—representing the first scene—with the second set of tags; and tagging the video file with the third set of tags.

### 2.1.4 Variation: Frame Selection+Viewership Data

In another variation, the second method S200 includes: accessing a video file; accessing a first set of viewership data for the video file; detecting a first viewership data characteristic in the first set of viewership data for the video file; extracting a first frame from the video file, the first frame corresponding to the first viewership data characteristic; serving the first frame and a prompt to generate tags, representing content within the first frame, to a model; receiving a first set of tags, representing content within the first frame, from the model; and tagging the video file with the first set of tags.

### 2.1.5 Variation: Viewership Data+Frame Selection Frequency

In yet another variation, the second method S200 includes: accessing a video file; accessing a first set of viewership data for the video file; selecting a first set of frames from the video file, the first set of frames selected at a frequency (or “pitch” internal) within the video file proportional to viewership of corresponding segments of the video file indicated in the first set of viewership data; serving the first set of frames and a prompt to generate tags, representing content within the first set of frames, to a model; receiving a first set of tags, representing content within the first set of frames, from the model; and tagging the video file with the first set of tags.

### 2.1.6 Variation: Scene Detection+Frame Selection

In yet another variation, the second method S200 includes: accessing a video file; detecting a set of scenes in the video file based on metadata associated with the video file; for each scene in the set of scenes, selecting a first frame in a first set of frames; serving the first set of frames and a prompt to generate tags, representing content within the first set of frames, to a model; receiving a first set of tags, representing content within the first set of frames, from the model; and tagging the video file with the first set of tags.

This variation of the second method S200 can further include: receiving the first set of tags, representing content within the first set of frames, from the model, each tag in the first set of tags corresponding to a frame in the first set of frames; and tagging each scene in the set of scenes with tags in the first set of tags according to corresponding frames.

### 2.1.7 Variation: Catalog Transfer+Natural Language Descriptions

In yet another variation, the second method S200 includes: accessing a video file; selecting a first frame from the video file; generating a prompt to generate a title, tags, and a natural language description representing content within the video file; serving the first frame and the prompt to a model; receiving the title, a first set of tags, and the natural language description from the model; tagging the video file with the first set of tags; and associating the title and the natural language description with the video file.

Additionally or alternatively, this variation of the second method S200 can include: accessing a video file; selecting a first set of frames from the video file; generating a prompt to generate a title, tags, and a natural language description representing content within the video file; serving the first set of frames and the prompt to a model; receiving the title, a first set of tags, and the natural language description from the model; tagging the video file with the first set of tags; and associating the title and the natural language description with the video file.

Additionally or alternatively, this variation of the method S200 can include ingesting a set of video files, and, for each video file in the set of video files: accessing a set of tags associated with semantic content in the video file; generating a natural language description of the video file based on the set of tags; and storing the natural language description of the video file in a container representing the video file.

### 2.2 Applications

Generally, the computer system (e.g., a computer network, a computer server) can execute Blocks of the method S200: to ingest a video file; extract a frame (e.g., a representative frame, a thumbnail, a keyframe) from the video file representing content of the video file; to compress the frame into a representative image for the video file, in a smaller file size than the frame; to serve the frame to a model (e.g., an image processing model) configured to return tags and/or natural language descriptions based on this frame; and to tag the video file with tags (and/or the natural language description) received from the model.

More specifically, the computer system can: select target frames in a video, such as by pseudo-randomly selecting frames, selecting frames based on viewership rate, or selecting frames representative of distinct scenes within the video file; compress this small selection of target frames into thumbnail images, such as while concurrently transcoding the video file into renditions; serve these thumbnail images to an artificial intelligence or large language model with a prompt to return natural language tags or a description of each thumbnail image; and then selectively tag frames in the video file, scenes in the video file, and/or the entire video file with such natural language tags or descriptions returned by the model. Accordingly, by transforming a minimal amount of visual content in a small quantity of representative (or “target”) frames in the video file into natural language tags and/or descriptions linked to the video, scenes, and individual frames, the computer system can enable natural language search of entire videos, specific scenes within videos, and/or specific frames within videos, thereby enabling users to more rapidly and seamlessly find and navigate to desired segments of videos based on natural language search queries, such as input at a video player connected to a video streaming platform.

Furthermore, by selecting a small count of specific representative frames in the video file and compressing these representative frames into thumbnails prior to serving these thumbnails to the model for interpretation, the computer system can limit both count and size of frames sent to and processed by the model—thereby reducing bandwidth consumption and computational load of the model—without substantive loss in completeness or accuracy of whole-video and scene tagging in the video file.

In one implementation, the computer system executes Blocks of the method S100 to annotate a specific frame, scenes, or a whole video—such as a stored video or in real-time upon ingestion or upload of the video—with natural language tags generated based on video content detected in specific frames in the video and/or a transcript of the video, these natural language tags indicating content of the video and locations (i.e. time stamps) of specific content to enable a user to more easily find desired, or “target,” content during a video search, such as at a video player. Additionally, the computer system can generate descriptions (e.g., natural language descriptions, titles) of this video to thereby enable a content creator (e.g., video content creator) to transport a catalog of videos between streaming platforms.

For example, the computer system can extract a first representative frame from a video file depicting a manufacturing process, serve the representative frame to the model with a prompt to generate tags describing objects and actions present in the representative frame, and receive a set of tags including “welding,” “protective gloves,” and “metal fabrication.” The computer system can associate the set of tags with a timestamp corresponding to the representative frame. In response to receiving a natural language query including the term “welding,” the computer system can identify the timestamp associated with the tag “welding” and initiate playback of a video segment corresponding to the timestamp.

Therefore, the computer system can extrapolate semantic information, derived from a (single) representative frame, to the video file to thereby reduce computational resources allocated to derivation of semantic and/or contextual data for this video file.

### 2.2.1 Example: Semantic Search+Relevance

In one application, a user may input a query (e.g., a natural language prompt, a search query) for a target concept (e.g., welding) to a video player. The video player can then: identify a video file (e.g., a video) associated with the target concept based on a set of tags associated with the video file; identify a timestamp of the video file defining a first video segment associated with a first tag corresponding to the target concept; and render the first video segment for the user.

For example, responsive to the user selecting the video file, the computer system can: receive a first request for playback of the video file in a first rendition; initiate transcoding of a first playback segment, corresponding to the first video segment, into the first rendition by a first worker; and serve the first playback segment, rather than serving an initial playback segment of the video file, from the first worker to the video player.

Therefore, by serving the user the playback segment of the video file corresponding to the target concept, the computer system can enable the user to view desired (or “relevant”) content within this video file without searching (or seeking) through the video file to discover this desired content.

### 2.2.2 Catalog Transfer+Natural Language Descriptions

In one implementation, the computer system can implement methods and techniques described herein, for a set of video files, to generate a natural language description for each video file in the set of video files to thereby enable a publisher, associated with the set of video files, to transfer the set of video files between video players without regenerating these descriptions during transfer of these video files.

For example, the model can implement artificial intelligence and/or a large language model to generate a textual description (e.g., “The frame appears to depict an amateur football game. The image depicts sparsely-populated bleachers” or “The video appears to describe an online game. One creator is streaming an instance of the online game.”) of the representative frame (or frames) and then return this textual description to the computer system. The computer system can then present the textual description to a user and/or associate the textual description with the video file to thereby enable the user to publish the video file with the textual description.

Therefore, the computer system can ingest a corpus of video files and derive descriptions and titles for these video files to thereby enable a user to transfer videos from one video streaming platform to a second video streaming platform while maintaining semantic searchability of these videos.

The method is described herein as executed by a remote computer system (e.g., a remote server, hereinafter a “computer system”). However, Blocks of the method S200 can be executed by one or more entities accessing the network, by a local computer system, or by any other computer system-hereinafter a “system.”

Additionally, the method is described herein as executed by a remote computer system for video files. However, the remote computer system can execute Blocks of the method S200 for any media file, such as video files, audio files, image files, text files, etc.

### 2.3 Frame Selection

Generally, the computer system can select a frame, and/or a set of frames, from a video file. In particular, the computer system can select a frame from a video file based on metadata associated with a video file—such as video complexity, video length, etc.

In one implementation, the computer system can pseudo-randomly select frames from the video file. In a similar implementation, the computer system can select frames from the video file based on scenes detected within the video file. For example, the computer system can: identify subsets of frames in the video file, these subsets of frames (e.g., continuous series of frames) representing scenes in the video file; and pseudo-randomly select frames from these subsets of frames (e.g., each subset of frames) in the video file.

Additionally or alternatively, the computer system can: detect subsets of frames representing scenes (e.g., based on clusters of semantically-related segments) in the video file; and, for each scene, select a frame from a start, a middle, and an end of the scene. For example, the computer system can: detect a first scene represented by a contiguous series of frames in the video file; select a first frame (e.g., an initial frame) proximal a beginning of the contiguous series of frames; select a second frame proximal a middle of the contiguous series of frames (e.g., pseudo-randomly selected from the contiguous series of frames); and select a third frame (e.g., a terminal frame) proximal a temporal end of the contiguous series of frames.

Similarly, the computer system can: define a first shot boundary, represented by a continuous series of frames in the video file, the continuous series of frames representing a single camera take; and (pseudorandomly) select a subset of frames from the continuous series of frames. For example, the computer system can define a first shot boundary based on temporal discontinuities or transitions between consecutive frames, and/or based on detecting (abrupt) transitions in frame-to-frame visual features (e.g., color histograms, edge maps, motion vectors, deep feature embeddings).

In another implementation, the computer system can select the frame based on a complexity of video. For example, the computer system can implement methods and techniques as described herein to: extract a set of characteristics (e.g., entropy characteristics) from the video file; and select a frame based on the set of characteristics. Additionally or alternatively, the computer system can extract a set of frames from the video file, a count of frames in the set of frames proportional to the set of characteristics (e.g., video complexity, entropy characteristics).

### 2.3.1 Frame Selection: Viewership Data

In one variation, the computer system can select a frame from a video file based on viewership data associated with the video file. In particular, the computer system can: access a first set of viewership data for the video file; detect a first viewership data characteristic in the first set of viewership data for the video file; and extract a first frame from the video file, the first frame corresponding to the first viewership data characteristic.

More specifically, the computer system can: access a set of viewership data associated with the video file; detect a segment of the video file defined by a viewership characteristic (e.g., an increased slope, a decreased slope, an inflection point, a maximum viewership, a minimum viewership) based on the set of viewership data; and select a frame from the segment of the video file.

In one example, the computer system can detect the first viewership data characteristic, including a first increase in viewership exceeding a threshold increase in viewership. Additionally or alternatively, the computer system can: detect a first viewership count falling below a threshold viewership count; and extract the first frame from the video file in response to the first viewership count falling below the threshold viewership count.

For example, the computer system can: access a set of viewership data associated with the video file; detect a segment of the video file defining a viewership count, based on the set of viewership data, exceeding a threshold viewership count; and select a frame from the segment of the video file.

Additionally or alternatively, the computer system can: access a set of viewership data associated with the video file; detect a segment of the video file defining a viewership count, based on the set of viewership data, falling below the threshold viewership count; and select a frame from the segment of the video file.

Additionally or alternatively, the computer system can: access a set of viewership data associated with the video file; detect a segment of the video file defining an inflection in viewership based on the set of viewership data; and select a frame from the segment of the video file.

For example, the computer system can: access a set of viewership data associated with the video file; detect a segment of the video file defining a viewership characteristic (e.g., an increased slope, an inflection point, a maximum viewership, a minimum viewership) based on the set of viewership data; and select a frame from the segment of the video file.

Additionally or alternatively, the computer system can: access a set of viewership data associated with the video file; detect a set of segments of the video file defining a viewership characteristic (e.g., an increased slope, an inflection point, a maximum viewership, a minimum viewership) based on the set of viewership data; and select a frame from each segment in the set of segments of the video file.

In one implementation, the computer system can extract frames from the video file proportional to a viewership increase and/or decrease.

In particular, the computer system can: detect a second viewership count, in the first set of viewership data, exceeding the threshold viewership count; extract a second frame, in the first resolution, corresponding to the second viewership count; extract a third frame, in the first resolution and proximal the second frame, in response to the second viewership count exceeding the threshold viewership count; convert the second frame and the third frame into a second representative image in the second resolution less than the first resolution; serve the second representative image to the model for generation of tags representing content in the second representative image; receive a second set of tags from the model; and tag the second frame and the third frame with the second set of tags.

Accordingly, the computer system can select a frame (and/or a set of frames) from a video file proportional to viewership of the video file.

Therefore, the computer system can selectively extract frames from the video file based on viewership data to constrain frame selection to segments and/or frames exhibiting defined viewership characteristics, and thereby limit a quantity of frames processed to reduce computational resources utilized for representative image generation and tag generation.

### 2.4 Frame Compression

In one implementation, the computer system can compress frames extracted (or “selected”) from a video file into a thumbnail. In particular, the computer system can implement methods and techniques as described above to compress the frame (or thumbnail) to a target resolution according to metadata (e.g., codec, renditions, video length, video complexity) associated with the video file.

For example, the computer system can: select a subset of frames from the video file; and compress the subset of frames into a thumbnail representing the subset of frames.

In another example, the computer system can: select a frame of a video file as described herein; and transcode this frame into a representative image of a (low) resolution and a (low) bitrate for serving to an image processing model as further described below.

In another example, the computer system can: select a frame from the video file, the first frame defining a first resolution; and compress the frame to a second resolution falling below the first resolution.

Therefore, by minimizing a file size of the frame and/or thumbnail prior to serving the frame to a model, the computer system can minimize a computational load on the model by minimizing data throughput without substantive loss in accuracy of tag generation as further described below.

### 2.5 Tag Specificity

Generally, the computer system can: pass a first frame, associated with a video file, and a prompt to generate tags representing content represented in the first frame (e.g., a thumbnail) to a model; and receive a set of tags (and/or a natural language description) from the model based on the first frame. In particular, the computer system can: implement methods and techniques as described herein to extract a first frame from a video file; generate a prompt to derive a set of tags representing content in the first frame and/or predicted content in the video file based on the first frame; pass the first frame and the prompt to a model (e.g., an image processing model, an artificial intelligence model); and receive the set of tags from the model.

In one implementation, the computer system can pass a thumbnail to the model with a prompt to generate frame-specific tags. For example, the computer system can: access the thumbnail associated with the video file; generate a prompt to generate frame-specific tags for the frame based on the thumbnail; serve the prompt and the thumbnail to the model; and receive a set of frame-specific tags from the model.

In another implementation, the computer system can pass a thumbnail to the model with a prompt to generate scene-specific tags. For example, the computer system can: access the thumbnail associated with the video file; generate a prompt to generate scene-specific tags, for a contiguous series of frames in the video file, based on the thumbnail; serve the prompt and the thumbnail to the model; and receive a set of scene-specific tags from the model.

In another implementation, the computer system can pass a thumbnail to the model with a prompt to generate video-specific tags. For example, the computer system can: access the thumbnail associated with the video file; generate a prompt to generate video-specific tags, for the entire video file, based on the thumbnail; serve the prompt and the thumbnail to the model; and receive a set of video-specific tags from the model.

Additionally or alternatively, the computer system can: implement methods and techniques as described herein to extract a first frame from a video file; generate a prompt to derive a natural language description representing content in the first frame and/or predicted content in the video file based on the first frame; pass the first frame and the prompt to a model (e.g., an image processing model, an artificial intelligence model); and receive the natural language description from the model.

In this implementation, the computer system can additionally or alternatively generate a set of tags based on the natural language description.

Therefore, the model can: predict content in the video file based on the first frame; and generate a set of tags and/or a natural language description for the video file based on this content.

### 2.6 Video Annotation

Generally, the computer system can annotate a frame in a video file, a contiguous series of frames in the video file, and/or the entire video file with tags received from the model.

In particular, in one implementation, the computer system can tag the first frame with the first set of tags. Additionally or alternatively, the computer system can tag a scene in the video file with a set of tags generated based on a first frame extracted from the video file.

For example, the computer system can: detect a set of scenes in the video file; select a first scene, in the set of scenes, corresponding to a first viewership data characteristic; extract the first frame from the first scene; and tag the first scene with the first set of tags. In particular, the computer system can: detect a contiguous series of frames, such as frames similar to the first frame; identify the contiguous series of frames as a scene in the video file; and tag the scene with the set of tags generated based on the first frame. In this implementation, the computer system can implement methods and techniques as described herein for each scene in a set of scenes defining the video file.

In a similar implementation, the computer system can: identify a set of frames similar to the first frame; identify scenes based on the set of frames; and tag these scenes with the set of tags generated based on the first frame.

Accordingly, by assigning tags to frames, scenes, and/or entire videos, the computer system can extrapolate tags generated based on a first frame (e.g., a single frame) extracted from a video file to the entire video file (and/or scenes in the video file).

Therefore, the computer system can: distribute tags generated by the model throughout the video file; and store tags with metadata (e.g., a header) for the video file to thereby minimize storage load for the video file.

### 2.7 Video Search Playback

Generally, the computer system can recommend and/or present a video segment of a video file to a user responsive to a request received from a video player for content related to a tag, associated with the video segment, in the set of tags.

In particular, the computer system can: receive a first request including a natural language prompt indicating a desired content type; access a set of video files, each video file associated with a set of tags; detect correlation between the natural language prompt and a first tag in a first set of tags associated with a first video file; and select the first video file for presentation in response to the first request.

Additionally or alternatively, the computer system can: receive a first request including a natural language prompt indicating a desired content type; access a set of video files, each video file associated with a set of tags; detect correlation between the natural language prompt and a first tag in a first set of tags associated with a first video file; identify a first video segment associated with the first tag; and render the first video segment, in a first rendition, responsive to the first request.

In particular, the computer system can: detect correspondence between the natural language prompt and a first tag in the set of tags corresponding to the timestamp associated with the first video segment; receive a first request for a second playback segment of the video file in the first rendition from the video player, the second playback segment associated with a second set of tags excluding the first tag; initiate transcoding of a first playback segment, corresponding to the first video segment, into the first rendition by a first worker; and serve the first playback segment, in place of the second playback segment, from the first worker to the video player.

Accordingly, in the foregoing variation, the computer system can selectively serve playback segments representing content semantically related to a search query input by the user.

### 2.8 Variation: Tag Validation

In one implementation, the computer system can validate tags generated by the model. In particular, the computer system can: receive a confidence score from the model, the confidence score representing confidence in the natural language tags representing content in the video file in Block S242; and, in response to the confidence score falling below a threshold confidence score, select a second frame from the video file and repeat methods and techniques as described herein to generate a second set of tags, for the video file, based on the second frame.

For example, the computer system can: receive a confidence score for the first set of tags from the model; in response to the confidence score falling below a threshold confidence score, convert a second frame into a second representative image in a third resolution less than the first resolution and greater than the second resolution; serve the second representative image to the model for generation of tags representing content in the second representative image; receive a second set of tags from the model; and replace a first set of tags—associated with the confidence score falling below the threshold confidence score—with the second set of tags in Block S258.

In another example, the computer system can implement methods and techniques as described herein to increase a frame extraction frequency in response to a confidence score, associated with a particular set of tags, falling below a threshold confidence score.

In particular, in this example, the computer system can: receive a confidence score for the first set of tags from the model, the confidence score proportional to a first count of frames for generation of a first representative image; and, in response to the confidence score falling below a threshold confidence score, extract a subset of frames from the video file, the subset of frames exhibiting a second count of frames exceeding the first count of frames. The computer system can then: convert the subset of frames into a second representative image in the second resolution; serve the second representative image to the model for generation of tags representing content in the second representative image; receive a second set of tags from the model; and replace a first set of tags—associated with the confidence score falling below the threshold confidence score—with the second set of tags.

Therefore, the computer system can iteratively validate and refine tags associated with a video file based on confidence scores returned by the model to reduce retention of low-confidence tags while constraining generation of higher-resolution representative images.

In one implementation, the computer system can select a second frame defining a second resolution greater than a first resolution of the first frame.

In one variation, the computer system can: receive a second confidence score from the model, the second confidence score representing confidence in the second set of natural language tags representing content in the video file; in response to the second confidence score falling below the threshold confidence score, select a third frame; and repeat methods and techniques as described herein to generate a second set of tags, for the video file, based on the third frame.

In another implementation, the computer system can: select a first set of frames for the video file; implement methods and techniques as described herein to generate (or receive) a first set of tags for the video file based on the set of frames; receive a first confidence score for the first set of tags, such as based on continuity of the first set of frames; in response to the first confidence score falling below the threshold confidence score, select a second set of frames from the video file; and repeat methods and techniques as described herein to generate a second set of tags for the video file based on the second set of frames. For example, in this implementation, the computer system can: receive a confidence score for each frame in the first set of frames; in response to a first confidence score falling below a threshold confidence score, select a second frame, in replacement of the first frame; and repeat methods and techniques as described herein to generate a second set of tags for the video file based on the second frame.

Additionally or alternatively, the computer system can: extract the first frame, at a second resolution exceeding a first resolution of the first set of frames; and repeat methods and techniques as described herein to generate a second set of tags for the video file based on the first frame at the second resolution. In this example, the computer system can: receive a second confidence score for the second set of tags based on the first frame at the second resolution; in response to the second confidence score falling below the threshold confidence score, select a second frame; and repeat methods and techniques as described herein to generate a second set of tags for the video file based on the second frame.

Additionally or alternatively, the computer system can: receive a second confidence score for the second set of tags based on the first frame at the second resolution; in response to the second confidence score falling below the threshold confidence score, identify the first frame as an outlier frame; and validate the second set of tags.

Accordingly, the computer system can: validate tags received from the model based on confidence scores generated by the model; and re-serve frames—such as higher resolution frames and/or alternative frames—to the model to prompt the model to generate a second set of tags based on these higher-quality or alternative frames.

### 2.9 Variation: Tag Complexity+Viewership Data

In one variation, succeeding publication of the video file, the computer system can: access a set of viewership data for the video file; derive a viewership count for the video file (e.g., for a target time period); in response to the viewership count falling below a threshold viewership count, repeat methods and techniques described herein to derive a second set of tags—such as a second set of tags defining a (higher) level of complexity inversely proportional to the viewership count. Additionally or alternatively, in response to the viewership count exceeding the threshold viewership count, the computer system can repeat methods and techniques described herein to derive a second set of tags—such as a second set of tags defining a (lower) level of complexity proportional to the viewership count.

In one implementation, in this variation, the computer system can: detect a first viewership count falling below a threshold viewership count; receive a first set of tags, of a first specificity proportional to the first viewership count, from the model; detect a second viewership count, in the first set of viewership data, exceeding the threshold viewership count; extract a second frame, in the first resolution, corresponding to the second viewership count; convert the second frame into a second representative image in the second resolution less than the first resolution; serve the second representative image to the model for generation of tags representing content in the second representative image; receive a second set of tags from the model, the second set of tags of a second specificity proportional to the second viewership count and greater than the first specificity; and tag the video file with the second set of tags.

For example, the computer system can: receive a first set of tags (e.g., panther, walking in a park), for a first representative image, in response to the first representative image corresponding to a first viewership count exceeding a threshold viewership count; and receive a second set of tags (e.g., cat, walking), for a second representative image, in response to the second representative image corresponding to a second viewership count falling below the threshold viewership count.

In the foregoing implementation, the computer system can prompt the model to generate tags of a particular specificity proportional to the viewership. Additionally or alternatively, the computer system can serve the representative image, the viewership count, and a prompt to generate tags of a particular count and/or specificity proportional to the viewership count.

In particular, the computer system can: detect a first viewership count falling below a threshold viewership count; access a prompt to generate a nominal count of tags proportional to the first viewership count; and serve the first representative image and the prompt to the model for generation of the nominal count of tags representing content in the first representative image. In this example, the computer system can: detect a second viewership data characteristic, including a second viewership count exceeding the threshold viewership count, in the first set of viewership data; extract a second frame, in the first resolution, from the video file, the second frame corresponding to the second viewership data characteristic; convert the second frame into a second representative image in the second resolution less than the first resolution; access a second prompt to generate a second count of tags, exceeding the nominal count of tags and proportional to the second viewership count, based on the second viewership data characteristic; serve the second representative image and the second prompt to the model for generation of the second count of tags representing content in the second representative image; receive a second set of tags, of the second count of tags, from the model; and tag the video file with the second set of tags.

Accordingly, in the foregoing example, the computer system can prompt the model to generate a count of tags proportional to viewership of a particular video segment in the video file.

In another example, the computer system can: detect a first viewership count falling below a threshold viewership count; access a prompt to generate genus-level (e.g., a first classification level) tags in response to the first viewership count falling below the threshold viewership count; and serve the first representative image and the prompt to the model for generation of genus-level tags representing content in the first representative image. In this example, the computer system can additionally: detect a second viewership data characteristic, including a second viewership count exceeding the threshold viewership count, in the first set of viewership data; extract a second frame, in the first resolution, from the video file, the second frame corresponding to the second viewership data characteristic; convert the second frame into a second representative image in the second resolution less than the first resolution; access a second prompt to generate species-level (e.g., a second classification level more specific than the first classification level) tags in response to the second viewership count exceeding the threshold viewership count; serve the second representative image and the second prompt to the model for generation of species-level tags representing content in the second representative image; receive a second set of tags, representing species-level tags, from the model; and tag the video file with the second set of tags.

Accordingly, in the foregoing example, the computer system can prompt the model to generate tags of a particular classification level proportional to viewership of a particular video segment in the video file.

Additionally or alternatively, succeeding publication of the video file, the computer system can: identify a count of instances of the video file being presented within search results within a video player; and, in response to the count of instances of the video file being presented within search results within the video player falling below a threshold count, repeat methods and techniques described herein to derive a second set of tags such as a second set of tags defining a (higher) level of complexity inversely proportional to the count of instances of the video file being presented within search results within the video player.

In one variation, the computer system can implement methods and techniques as described herein for a live video stream. In particular, during streaming of the live video, the computer system can: detect a first viewership count falling below a threshold viewership count; access a prompt to generate genus-level tags in response to the first viewership count falling below the threshold viewership count; serve the first representative image and the prompt to the model for generation of genus-level tags representing content in the first representative image; and tag a video feed of the live video with a first genus-level set of tags. In this example, during streaming of the live video, the computer system can then: detect a second viewership data characteristic, including a second viewership count exceeding the threshold viewership count, in the first set of viewership data; extract a second frame, in the first resolution, from the video file, the second frame corresponding to the second viewership data characteristic; convert the second frame into a second representative image in the second resolution less than the first resolution; access a second prompt to generate species-level tags in response to the second viewership count exceeding the threshold viewership count; serve the second representative image and the second prompt to the model for generation of species-level tags representing content in the second representative image; receive a second set of tags, representing species-level tags, from the model; and tag the video file with the second set of species-level tags.

Accordingly, the computer system can dynamically update tags associated with video files based on performance (e.g., viewership) of these video files within a video player.

Therefore, the computer system can generate and/or receive tags of a particular specificity for a video file based on viewership data to selectively apply higher-specificity tags to video files exhibiting higher viewership to thereby constrain semantic detail and reduce computational resources allocated to tag generation for video files and/or segments of a video file exhibiting viewership falling below a particular threshold viewership.

### 2.10 Variation: Natural Language Descriptions+Viewership Insights+Content Assembly

In one variation, the computer system can: identify segments of a video file according to viewership characteristics of the video file; implement methods and techniques as described herein to derive natural language descriptions for these segments of the video file; and serve these natural language descriptions to a publisher associated with the video file.

For example, the computer system can: access a set of viewership data associated with the video file; detect a segment of the video file defining a viewership characteristic (e.g., an increased slope, an inflection point, a maximum viewership, a minimum viewership) based on the set of viewership data; and select a frame from the segment of the video file.

Additionally or alternatively, the computer system can: access a set of viewership data associated with the video file; detect a set of segments of the video file defining a viewership characteristic (e.g., an increased slope, an inflection point, a maximum viewership, a minimum viewership) based on the set of viewership data; and select a frame from each segment in the set of segments of the video file.

In this variation, the computer system can: extract a frame (and/or set of frames) from a particular video file; compress the frame into a representative image; serve the representative image and a prompt to generate a natural language description of the representative image to a model; and receive the natural language description, representing content within the frame and/or set of frames, from the model.

Accordingly, the computer system can identify video segments defined by viewership characteristics to thereby enable the publisher to identify high-performing and/or low-performing segments of video files uploaded to a video player by the publisher.

Additionally or alternatively, the computer system can assemble segments of video files into a representative video file for the publisher. For example, for a first video file including a set of video segments, the computer system can: select a subset of video segments in the set of video segments according to viewership data (e.g., viewership exceeding a threshold viewership) for the set of video segments; and assemble the subset of video segments into a second video file.

In one implementation, the computer system can: access a video file including a set of video segments; access a set of viewership data—for viewership of the set of video segments in a set of renditions—for the video file; derive a viewership count for each video segment in the set of video segments according to the set of viewership data; identify a first video segment defined by a first viewership count exceeding a threshold viewership count; identify a second video segment defined by a second viewership count exceeding the threshold viewership count; and assemble the first video segment and the second video segment into a second video file.

For example, the computer system can: access the video file associated with a first publisher in Block S210; detect a first viewership data characteristic including a first increase in viewership exceeding a threshold increase in viewership; extract the first frame corresponding to the first increase in viewership; and extract a first subset of frames, from the video file, proximal the first frame and corresponding to the first increase in viewership in Block S270. Additionally, for a second video file associated with the first publisher, the computer system can: access a second set of viewership data for the second video file; detect a second increase in viewership, exceeding the threshold increase in viewership, in the second set of viewership data; extract a second subset of frames, from the second video file, corresponding to the second increase in viewership in Block S272; assemble the first subset of frames and the second subset of frames into a third video file representing engagement-weighted video segments (e.g., highlight clips, highlight reels) associated with the first publisher in Block S274; and serve the third video file to the first publisher via a publisher portal in Block S276.

Accordingly, the computer system can generate and/or assemble video files representing highly viewed content associated with a video file, and therefore assemble highly viewed content associated with a publisher to thereby enable this publisher to display popular content on a publisher profile associated with the publisher.

Additionally or alternatively, the computer system can: identify a first video segment defined by a first viewership count exceeding a threshold viewership count; identify a second video segment characterized by a semantic similarity to the first video segment; and assemble the first video segment and the second video segment into a second video file.

Therefore, the computer system can assemble video segments into video files based on video characteristics (e.g., viewership data, semantic similarity) to enable a publisher to direct viewers to relevant and/or popular video (or video) clips associated with the publisher.

### 2.11 Viewership Changes: Video Insights

In one variation, the computer system can implement methods and techniques as described herein to serve feedback to a publisher—based on content represented in videos published by the publisher—according to viewership changes associated with or contained in segments of the video file.

For example, the computer system can: access the video file associated with a first publisher; detect a first viewership data characteristic, including a first increase in viewership exceeding a threshold increase in viewership; and generate a prompt for a natural language description of content in the first representative image. The computer system can then: receive the natural language description from the model in Block S254; generate a report including the first increase in viewership, the natural language description, and a recommendation to continue generating content similar to content in the first frame in Block S260; and serve the report to the first publisher via a publisher portal in Block S262.

Additionally or alternatively, the computer system can: access the video file associated with a first publisher; detect a first viewership data characteristic, including a first decrease in viewership exceeding a threshold decrease in viewership; and generate a prompt for a natural language description of content in the first representative image.

The computer system can then: receive the natural language description from the model; generate a report including the first decrease in viewership, the natural language description, and a recommendation to discontinue generating content similar to content in the first frame; and serve the report to the first publisher via a publisher portal.

In one example, for a (published) video file associated with a publisher, the computer system can: access viewership data captured by a video platform during playback of (many) instances of the video at user devices; and detect a viewership change in these viewership data, such as rate of viewership increase or decrease greater than a threshold rate of change, percentage viewership change within a time interval in excess of a threshold percentage, ratio of video segment viewership differing from an average viewership over the whole video by more than threshold difference, and/or populations of viewers for video segments of the video differing by greater than a threshold difference. The computer system can then: select a (sub)set of frames within the video approximately concurrent (e.g., played back immediately before, during, and/or immediately after) the viewership change, and serve these frames—or compressed (or “thumbnail”) images of these frames—to the model for characterization of content presented in the video during a period of significant viewership change in the video. The computer system can then present this characterization of content immediately before, during, and/or immediately after this viewership change with a description of the viewership change (e.g., rapid increase or decrease in viewership) to the publisher, such as in text form or in the form of a video clip spanning this viewership change, augmented with text description. The computer system can thus enable the publisher to directly and clearly review and discern video content correlated with change in viewership in this video.

The computer system can also: execute this process for multiple viewership change instances within this single video and/or for viewership change instances across many videos published by the publisher (or group of publishers or other entity) in order to generate multiple textual descriptions of video content correlated with significant viewership changes; and then serve these textual descriptions to the model for fusion into a more robust, comprehensive textual summary of cross-video content (e.g., the publisher's entire video catalog) that produced particular, characterized changes in viewership. By presenting this summary to the publisher, the computer system can thus enable the publisher to quickly identify visual (and audible) content within her videos that results in increased or decreased viewership, which the publisher may then leverage to develop more engaging and focused video content.

In one example, the computer system: detects an instance of a decrease in viewership greater than a threshold decrease in viewership; and extracts a set of frames, proximal (e.g., within a particular time frame of, within a particular frame count of) the instance of the decrease in viewership, from the video file. In particular, the computer system can: increase a frequency and/or a count of frame selection for frames proximal the instance of a decrease in viewership. Additionally or alternatively, the computer system can select only frames proximal the instance of decrease in viewership.

Then, the computer system can: pass the set of frames, and a prompt to generate natural language descriptions describing content represented in the set of frames, to a model; and receive, from the model, a natural language description of content represented in the set of frames.

The computer system can then: characterize a content type of content represented in the set of frames based on the natural language description of the set of frames; tag the set of frames with the decrease in viewership (e.g., a timestamp associated with the decrease in viewership); and serve the type of content and the set of frames, tagged with the decrease in viewership, to the publisher.

For example, the computer system can: identify content types (e.g., activities, objects, actions, absence of activities, absence of objects, absence of actions) present in the video file during the decrease in viewership; and serve these content types to the publisher, tagged with the decrease in viewership, to thereby enable the publisher to directly review video content correlated with decrease in viewership in this video.

Therefore, the computer system can annotate a change in viewership (e.g., percentage viewership change in excess of a threshold percentage) with a description of visual features in frames proximal the change in viewership to thereby contextualize the change in viewership for the publisher.

### 2.11.1 Comments: Textual Descriptions+Contextual Annotation

In one implementation, the computer system implements methods and techniques as described herein to: ingest a comment associated with a video file; identify a scene (or a set of frames) in the video file correlating with content in the comment; and link a natural language description of the scene with the comment to enable viewers of the video to identify moments in the video correlated with (or related to) the comment.

For example, the computer system can: implement methods and techniques as described herein to generate natural language descriptions for scenes in a particular video; ingest a set of comments associated with (e.g., published on) the video; for a particular comment in the set of comments, extract a set of language signals from the comment; identify a first scene in the video file correlated with the set of language signals—such as based on a natural language description generated by the model and associated with the first scene; and associate the particular comment with the first scene. In one example, the computer system can link the comment to a timestamp associated with a first frame in the first scene. Additionally or alternatively, the computer system can annotate the timestamp associated with the first frame in the first scene with the comment and/or the set of language signals.

Additionally or alternatively, the computer system can leverage content in the set of comments to select frames in the video. For example, the computer system can: identify the timestamp linked to the comment as described above; define a time window (e.g., five seconds before and after, ten percent of the video duration) around the timestamp; select a set of frames from the time window; and implement methods and techniques as described herein to derive natural language descriptions and/or a set of tags for the video file based on the set of frames.

Accordingly, the computer system can generate and/or update tags (or natural language descriptions) for a video file after the video file has been published, such as based on comments and viewership captured by a video platform hosting the video file.

The computer system can implement methods and techniques as described herein for additional data types associated with the video file, such as: seek positions and/or a timestamp in the video file that a player jumps to during a scrub forward or a scrub backward event; “like” instances; “dislike” instances; “subscribe” instances; etc.

Therefore, in the foregoing variations, the computer system can leverage data captured by a video platform hosting the video file to generate descriptions of engagement characteristics of the video file to thereby enable the publisher to review these engagement characteristics and increase engagement with these future video files generated by the publisher.

Additionally, in the foregoing variations, the computer system can further inform selection of frames for the video file for generation of tags and/or natural language descriptions—as described herein—for the video file and/or video files in a video catalog for a publisher.

### 2.12 Variation: Multi-Frame Video Object

In one variation, the computer system can implement methods and techniques as described herein to generate a representative video object (e.g., a representative image) for a particular video file according to a particular set of selection parameters, such as video resolution, entropy characteristics, etc. In this variation, the computer system can generate the representative video object based on: a target frame as described above; a transcript associated with the video file (and/or portions of the video file); and/or an audio file associated with the video file (and/or portions of the video file). Then, the computer system can implement methods and techniques as described herein to: pass the representative video object and a prompt to a model, the prompt requesting natural language description tags for the video file (and/or a frame in the video file; and/or a series of frames in the video file) based on the representative video object; receive a set of natural language tags from the model; and tag portions of the video file with the set of natural language tags as described above.

Therefore, the computer system can serve additional contextual information—such as audio and/or text context—to the model to thereby enable the model to generate natural language tags while still reducing bandwidth consumption and computational load of the model—without substantive loss in completeness or accuracy of whole—video and scene tagging in the video file.

In one implementation, the computer system can: access a video file (e.g., a video file); and analyze segments of the video file for visual (or nonvisual) characteristics. For example, the computer system can: access a video file (e.g., a video file); extract a set of visual (or nonvisual) characteristics from the video file, such as entropy characteristics representing a complexity of the video file; and select a set of frames for compression into a representative video object (e.g., a representative image) for the video file, the count of frames in the set of frames proportional to the complexity of the video file; and generate the representative video object based on the set of frames. In another example, the computer system can: detect a subset of frames (e.g., a set of keyframes), in a set of frames defining a video file, the subset of frames defined for the video file; and generate a proxy video representation including the subset of frames. Additionally or alternatively, the computer system can derive complexity characteristics of the video based on pixel and/or encoding characteristics extracted from an encoded video file.

In one implementation, the computer system can: select a representative video object for a particular video file as described herein; access a model configured to derive video characteristics of the representative video object; receive a set of video characteristics for the representative video object based on the model; and generate the set of tags, for the video file, based on the set of video characteristics for the representative video object.

Accordingly, the computer system can automatically generate and/or access a set of tags based on visual and/or audio characteristics for a particular video file and annotate the video file with the set of tags, thereby increasing contextual cues for a viewer and/or assisting a user in discovering the video file on the video player based on target content types.

Therefore, the computer system can extrapolate semantic information derived from a (single) frame (or other representative video object) to the video file to thereby reduce computational resources allocated to derivation of semantic and/or contextual data for this video file.

### 2.12.1 Video Objects: Transcript Augmentation

In one variation, the computer system can: access a transcript associated with the video file; extract a frame from a video file; generate a prompt to derive a natural language description representing content in the frame and/or predicted content in the video file based on the frame and the transcript; pass the transcript, the frame, and the prompt to a model (e.g., an image processing model, an artificial intelligence model); and receive the natural language description from the model. In one example, the computer system can generate and/or access a prompt to generate natural language descriptions of content represented in the frame, content represented in a scene, including the frame, based on the frame and the transcript, and content represented in the video file based on the frame and the transcript. Additionally or alternatively, in this variation, the computer system can generate the transcript based on the video file.

In a similar implementation, the computer system can: access a transcript associated with the video file in Block S280; extract a transcript segment, from the transcript, associated with the first frame in Block S282; and serve the first representative image and the transcript segment to the model for generation of tags representing content in the first representative image based on the transcript segment in Block S240.

Additionally or alternatively, the computer system can: access an audio file associated with the video file in Block S284; extract an audio segment, from the audio file, associated with the first frame in Block S286; and serve the first representative image and the audio segment to the model for generation of tags representing content in the first representative image based on the audio segment in Block S240.

Therefore, the computer system can supply the model with contextual data to enable the model to generate accurate tags and/or natural language descriptions for the video file.

### 2.13 Catalog Transfer: Titles+Descriptions

In one variation, the computer system can implement methods and techniques as described herein to generate natural language descriptions, titles (e.g., platform agnostic title), and/or other tags for each video in a corpus of videos, such that these natural language descriptions and/or titles and/or other tags may be distributed across a set of video player platforms.

In particular, the computer system can: receive a catalog of video files associated with a publisher; and implement methods and techniques described herein to derive a natural language description for each video file in the catalog of video files.

For example, the computer system can access a catalog of video files associated with a publisher, such as video files uploaded to a video player and, for each video file in the catalog of video files: select a frame in the video file; generate a set of natural language tags based on the frame and representing content within the video file—such as based on passing the frame to a model as described herein; and generate a natural language description for the video file based on the set of natural language tags.

In another example, the computer system can: access a prompt to generate a natural language description of the video file based on the first representative image; serve the first representative image and the prompt to the model for generation of tags representing content in the first representative image and the natural language description; and insert the natural language description into a description field associated with the video file in Block S256.

In a similar example, the computer system can: access a prompt to generate a title of the video file based on the first representative image; serve the first representative image and the prompt to the model for generation of tags representing content in the first representative image and the title; and insert the title into a title field associated with the video file.

Therefore, the computer system can generate natural language descriptions (and/or titles) for a catalog of video files to thereby enable a publisher to directly import these video files—and associated natural language descriptions—to the additional video players.

### 2.14 Example: Customer Support Filters+Content Generation

In one variation, the computer system can implement methods and techniques as described herein to: characterize content of video files received from customers, such as customer support requests; characterize descriptions of these video files; and filter customer support requests according to content of these video files and descriptions of these video files.

For example, the computer system can access a set of video files representing customer support requests and, for each video file in the set of video files: extract a frame from a video file; generate a prompt to derive a natural language description representing content in the frame and/or predicted content in the video file based on the frame; pass the frame and the prompt to a model (e.g., an image processing model, an artificial intelligence model); and receive the natural language description from the model.

The computer system can then, for each video file in the set of video files: access a description of the video file input by a customer associated with uploading the video file; extract a set of language signals from the description of the video file; calculate a correlation between the set of language signals and the natural language description representing content in the video file; and, in response to the correlation exceeding a threshold correlation, validate that content represented in the video file corresponds to a description of the video file.

Additionally, in this variation, the computer system can: access a set of rules (e.g., a policy) for customer service requests, the set of rules defining inclusion (e.g., water leaks, broken objects) and exclusion (e.g., nude content, moderated content) concepts for customer service requests; and, in response to content represented in the video file correlating with inclusion concepts according to the set of rules, pass the video file to the customer support portal.

Additionally or alternatively, in response to content represented in the video file correlating with exclusion concepts according to the set of rules, the computer system can: withhold passing the video file to the customer support portal; and discard the video file.

Accordingly, the computer system can: detect correspondence between content represented in a video file and a description of the video file; and validate that content represented in a video file and the description of the video file represent a legitimate customer service request.

Therefore, the computer system can validate that a customer support request represents a legitimate request, and selectively pass customer support requests to a customer support portal responsive to detecting a valid customer support request, thereby preventing customer support representatives viewing moderated content and/or decreasing an amount of content that a customer support representative may review, thereby increasing efficiency of these customer support representatives.

### 2.15 Variation: Product Detection+Product Placement

In one variation, the computer system can implement methods and techniques as described herein to detect presence of objects in a target video file. In particular, the computer system can implement methods and techniques as described herein to detect presence of brand objects (e.g., products) within a target video.

In one implementation, the computer system can implement methods and techniques as described herein to: extract a frame (and/or a subset of frames) from a video file; compress the frame (and/or subset of frames) into a representative image; and serve the representative image and a prompt to identify objects present in the representative image to a model. Then, the computer system can: receive a list of objects shown in the video file based on the representative image, such as a set of tags representing the list of objects shown in the video file; and tag the video file with the list of objects.

Additionally or alternatively, the computer system can prompt the model to return additional contextual data about objects detected in the representative image. For example, the computer system can receive a location (e.g., foreground, background)—or a series of locations—of the object in the video file based on the representative image (or a series of representative images) from the model. In particular, the computer system can: serve the representative image and a prompt to a) identify objects present in the representative image and b) identify locations of these objects in the representative image to a model; receive a list of objects shown in the video file based on the representative image from the model, such as a set of tags representing the list of objects shown in the video file and locations of each object in the list of objects; and tag the video file with the list of objects.

In another implementation, the computer system can: access a list of target brand icons (e.g., brand logos, brand iconography, images of brand products); and serve the representative image, the list of target brand icons, and a prompt to identify target brand icons present in the representative image to the model. The computer system can then: receive identification of a first target brand icon, in the list of target brand icons, in a particular representative image associated with a particular video file; generate a notification of presence of the first target brand icon; and transmit the notification to a brand administrator associated with a brand represented by the first target brand icon.

In particular, in this implementation, the computer system can: access a set of viewership data for a particular video file; and, in response to the set of viewership data specifying a viewership count exceeding a threshold viewership count, implement methods and techniques as described herein to generate a notification of presence of the first target brand icon in the particular video file and transmit the notification to a brand administrator associated with a brand represented by the first target brand icon.

Accordingly, the computer system can selectively notify brand administrators of presence of brand objects in video files exhibiting viewership exceeding a threshold viewership.

In a similar implementation, the computer system can: receive detection of a particular brand object in a particular representative image (e.g., a representative image representing a sequence of frames in a video file); access a transcript segment, associated with the video file, temporally intersecting the sequence of frames; serve the transcript segment and a representation of the particular brand object to the model with a prompt to characterize a sentiment for the particular brand object; receive the sentiment (e.g., positive, negative, supportive, derogatory) for the particular brand object based on the transcript segment from the model; and generate a notification of presence of the first target brand icon in the particular video file, characterized by the sentiment, and transmit the notification to a brand administrator associated with a brand represented by the first target brand icon.

In one example, the computer system can: access a transcript segment, associated with the video file, temporally intersecting the sequence of frames; extract a set of language signals associated with the particular brand object from the transcript segment; serve the set of language signals to the model with a prompt to characterize a sentiment for the particular brand object; receive the sentiment (e.g., positive, negative, supportive, derogatory) for the particular brand object based on the transcript segment from the model; generate a notification of presence of the first target brand icon in the particular video file, characterized by the sentiment; and transmit the notification to a brand administrator associated with a brand represented by the first target brand icon.

In another similar implementation, for a video file exhibiting a viewership count exceeding a threshold viewership count, the computer system can: receive detection of a particular brand object in the video file from the model; receive a positive sentiment associated with the particular brand object from the model; in response to the viewership count exceeding the threshold viewership count, generate a notification of presence of the first target brand icon in the particular video file, characterized by the positive sentiment; and transmit the notification to a brand administrator associated with a brand represented by the first target brand icon. In particular, in this example, the computer system can enable the brand administrator to place an ad, for the particular brand object, within and/or proximal the video file displaying the particular brand object.

Additionally or alternatively, in this variation, the computer system can compare visual presence of particular brand objects across distinct brands (e.g., competitors).

In particular, the computer system can: receive detection of a first brand object, associated with a first brand, in a particular video file, from the model; and receive detection of a second brand object, associated with a second brand (e.g., a competitor brand to the first brand), in the particular video file, from the model. The computer system can then: serve the video file to the model with a prompt to compare presence of the first brand object and the second brand object in the video file; receive a first duration value, corresponding to a total time that the first brand object was present within the video file, from the model; receive a second duration value, corresponding to a total time the second brand object was present within the video file, from the model; and, in response to the first duration value exceeding the second duration value, generate a notification to the first brand administrator specifying presence of the first brand object for a greater total time than the second brand object based on the first duration value and the second duration value.

Additionally or alternatively, in response to the first duration value falling below the second duration value, the computer system can generate a notification to the first brand administrator specifying presence of the second brand object for a greater total time than the second brand object based on the first duration value and the second duration value.

Additionally or alternatively, the computer system can implement methods and techniques as described herein to identify brand objects in response to detecting a viewership count exceeding a threshold viewership count.

For example, for a video file defined by a total viewership count exceeding a threshold total viewership count, the computer system can: access a first set of viewership data for the video file; detect a first viewership data characteristic in the first set of viewership data for the video file, the first viewership data characteristic corresponding to a maximum viewership; extract a frame, corresponding to the first viewership data characteristic, from the video file; compress the frame into a representative image; serve the representative image to a model for identification of brand objects in the first representative image; and, in response to receiving detection of a target brand object, associated with a target brand, in the representative image from the model, generate a notification to a brand administrator associated with the target brand of presence of the target brand object in the video file.

Additionally or alternatively, the computer system can implement methods and techniques as described herein to notify a publisher of presence of brand objects shown during maximum viewership of a particular publisher video file to prompt the publisher to initiate a brand deal with a brand associated with these brand objects.

Therefore, the computer system can identify brand objects in video files based on minimal video file data (e.g., single frames, representative images of single frames) and serve brand insights to creators and brand administrators to enable these creators and brand administrators to identify product placement in video files published on a particular video platform while minimizing computational resources consumed by the model and the computer system.

### 2.15.1 Content Detection+Contract Fulfillment

In one variation, the computer system implements methods and techniques described herein to verify fulfillment of a contractual obligation associated with a video file. In particular, the computer system can: access a target video file published by a publisher (e.g., an influencer); access a contract associated with the target video file, the contract specifying one or more performance conditions related to presence of a target brand object within the target video file; and extract a set of contractual parameters (e.g., a minimum duration of visual presence of the target brand object within the target video file) from the contract. The computer system can then: implement methods and techniques as described herein to detect the target brand object within the target video file; calculate a measured duration value corresponding to total time the target brand object is visually present within the target video file; and compare the measured duration value to the minimum duration specified in the contract. In response to the measured duration value meeting or exceeding the minimum duration specified in the contract, the computer system can generate a fulfillment confirmation record associated with the contract.

Additionally or alternatively, the computer system can implement methods and techniques described herein to verify additional contractual conditions. For example, the computer system can implement methods and techniques as described herein to: detect a spatial prominence characteristic of the target brand object within the target video file; detect a temporal placement characteristic of the target brand object within the target video file; access a transcript segment temporally intersecting presence of the target brand object; characterize sentiment associated with the target brand object based on the transcript segment; and compare these characteristics to corresponding contractual parameters specifying placement position, prominence threshold, and sentiment requirement. In response to detecting absence of fulfillment of a particular contractual parameter, the computer system can generate a non-fulfillment notification and transmit the notification to a brand administrator, a publisher, or a contract management system.

Therefore, the computer system can automatically evaluate influencer content against contractual requirements and generate auditable fulfillment records based on detected visual presence, contextual attributes, and engagement characteristics of brand objects within the target video file.

### 2.15.2 Variation: Ad Recommendations

In one variation, the computer system can generate a recommendation for advertisement placement in a video file associated with a particular brand object. For example, in response to detecting presence of a first brand object within a video file, the computer system can: generate a notification to a brand administrator associated with the first brand specifying detection of the first brand object within the video file; generate a recommendation to advertise the first brand within or proximal the video file; and serve a link, identifier, or interface enabling purchase of an advertisement slot corresponding to a designated segment of the video file. Therefore, the computer system can leverage detected product presence and engagement characteristics of video content to recommend and facilitate targeted advertisement placement within video files displaying corresponding brand objects.

### 2.15.3 Variation: Ad Slots

In another variation, the computer system can implement methods and techniques as described herein to identify candidate advertisement slots within a video file based on contextual transitions within the video file. In particular, the computer system can: implement methods and techniques as described herein to segment the video file into a set of scenes, such as based on visual discontinuities, audio transitions, transcript changes, and/or engagement inflection points; detect a particular contextual break between adjacent scenes in the set of scenes; and select the particular contextual break as a candidate advertisement slot based on a transition characteristic associated with the contextual break. The computer system can then store metadata defining a temporal position and duration associated with the candidate advertisement slot to enable insertion of an advertisement at the contextual break within the video file.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a video comprising a set of mezzanine segments; and
in response to receiving a first request, at a first time, for a first rendition segment of the video in a first rendition from a first video player:
initiating transcoding of a first mezzanine segment, in the set of mezzanine segments, into the first rendition segment in the first rendition;
enabling distribution of the first rendition segment to the video player;
extracting a first frame in a first resolution from the video;
converting the first frame into a first representative image in a second resolution less than the first resolution;
serving the first representative image to an image processing model for detection of moderated content in the first representative image; and
in response to the image processing model returning detection of moderated content in the first representative image:
disabling transcoding of the set of mezzanine segments into rendition segments in the first rendition; and
disabling distribution of rendition segments in the first rendition of the video.

2. The method of claim 1:
further comprising, in response to receiving a second request, at a second time preceding the first time, for a second rendition segment of the video in the first rendition from the first video player:
initiating transcoding of a second mezzanine segment, in the set of mezzanine segments and preceding the first mezzanine segment, into the second rendition segment in the first rendition;
enabling distribution of the second rendition segment to the video player;
extracting a second frame, in the first resolution, from the video;
converting the second frame into a second representative image in the second resolution;
serving the second representative image to the image processing model for detection of moderated content in the second representative image; and
in response to the image processing model failing to detect presence of moderated content in the second representative image, maintaining transcoding of the set of mezzanine segments into rendition segments in the first rendition; and
wherein initiating transcoding of the first mezzanine segment, in the set of mezzanine segments, into the first rendition segment in the first rendition comprises:
in response to the image processing model failing to detect presence of moderated content in the second representative image, initiating transcoding of the first mezzanine segment, in the set of mezzanine segments, into the first rendition segment in the first rendition.

3. The method of claim 1:
further comprising, in response to receiving a second request, at a second time preceding the first time, for a second rendition segment of the video in the first rendition from the first video player:
initiating transcoding of a second mezzanine segment, in the set of mezzanine segments and preceding the first mezzanine segment, into the second rendition segment in the first rendition;
enabling distribution of the second rendition segment to the video player;
extracting a second frame, in a third resolution less than the first resolution, from the video;
converting the second frame into a second representative image in a fourth resolution less than the third resolution;
serving the second representative image to the image processing model for detection of moderated content in the second representative image;
receiving detection of moderated content in the second representative image from the image processing model;
receiving a first confidence score from the image processing model, the first confidence score representing confidence of detection of moderated content in the second representative image; and
in response to the first confidence score falling below a threshold confidence score, maintaining transcoding of the set of mezzanine segments into rendition segments in the first rendition;
wherein converting the first frame into the first representative image in the second resolution less than the first resolution comprises converting the first frame into the first representative image in the second resolution less than the first resolution and greater than the fourth resolution;
further comprising receiving a second confidence score from the image processing model, the second confidence score representing confidence of detection of moderated content in the first representative image; and
wherein disabling transcoding of the set of mezzanine segments into rendition segments in the first rendition comprises, in response to the second confidence score exceeding the threshold confidence score, disabling transcoding of the set of mezzanine segments into rendition segments in the first rendition.

4. The method of claim 1:
further comprising, in response to receiving a second request, at a second time preceding the first time, for a second rendition segment of the video in the first rendition from the first video player:
initiating transcoding of a second mezzanine segment, in the set of mezzanine segments and preceding the first mezzanine segment, into the second rendition segment in the first rendition;
enabling distribution of the second rendition segment to the video player;
extracting a second frame, in the first resolution, from the video;
converting the second frame into a second representative image in the second resolution;
serving the second representative image to the image processing model for detection of moderated content in the second representative image;
receiving detection of moderated content in the second representative image from the image processing model;
receiving a first confidence score from the image processing model, the first confidence score representing confidence of detection of moderated content in the second representative image; and
in response to the first confidence score falling below a threshold confidence score, maintaining transcoding of the set of mezzanine segments into rendition segments in the first rendition;
wherein extracting the first frame in the first resolution from the video comprises extracting the first frame and a second frame, in the first resolution, from the video;
wherein converting the first frame into the first representative image comprises compressing the first frame and the second frame into the first representative image in the second resolution;
further comprising receiving a second confidence score from the image processing model, the second confidence score representing confidence in detection of moderated content in the first representative image; and
wherein disabling transcoding of the set of mezzanine segments into rendition segments in the first rendition comprises, in response to the second confidence score exceeding the threshold confidence score, disabling transcoding of the set of mezzanine segments into rendition segments in the first rendition.

5. The method of claim 4:
wherein extracting the second frame, in the first resolution, from the video comprises extracting the second frame from the video according to a first frame extraction frequency; and
wherein extracting the first frame in the first resolution from the video comprises extracting the first frame and a second frame, in the first resolution, from the video according to a second frame extraction frequency exceeding the first frame extraction frequency in response to the first confidence score falling below the threshold confidence score.

6. The method of claim 1:
further comprising, in response to ingest of the video during a second time preceding the first time:
extracting a second frame, in the first resolution, from the video;
converting the second frame into a second representative image in the second resolution;
serving the second representative image to the image processing model for detection of moderated content in the second representative image; and
in response to the image processing model failing to detect presence of moderated content in the second representative image, maintaining transcoding of the set of mezzanine segments into rendition segments in the first rendition; and
wherein initiating transcoding of the first mezzanine segment, in the set of mezzanine segments, into the first rendition segment in the first rendition comprises:
in response to the image processing model failing to detect presence of moderated content in the second representative image, initiating transcoding of the first mezzanine segment, in the set of mezzanine segments, into the first rendition segment in the first rendition.

7. The method of claim 1:
further comprising, in response to receiving the first request for the first rendition segment of the video in the first rendition from the first video player:
extracting a second frame, in the first resolution, from the video, the second frame:
nonconsecutive with the first frame; and
offset from the first frame in the video according to a first frame extraction frequency; and
wherein converting the first frame into the first representative image comprises:
compressing the first frame into a first thumbnail image in the second resolution;
compressing the second frame into a second thumbnail image in the second resolution; and
compositing the first thumbnail image and the second thumbnail image into the first representative image in the second resolution.

8. The method of claim 1:
further comprising:
detecting a first scene in the video, the first scene spanning:
a second mezzanine segment preceding the first mezzanine segment; and
a third mezzanine segment preceding the first mezzanine segment; and
in response to receiving a second request, at a second time preceding the first time, for a second rendition segment of the video in the first rendition from the first video player:
extracting a second frame, in the first resolution, from the second mezzanine segment;
converting the second frame into a second representative image in the second resolution;
serving the second representative image to the image processing model for detection of moderated content in the second representative image; and
in response to the image processing model failing to detect presence of moderated content in the second representative image:
initiating transcoding of the second mezzanine segment, in the set of mezzanine segments, into the second rendition segment in the first rendition;
initiating transcoding of the third mezzanine segment, in the set of mezzanine segments, into a third rendition segment in the first rendition; and
enabling distribution of the second rendition segment and the third rendition segment to the video player; and
wherein initiating transcoding of the first mezzanine segment, in the set of mezzanine segments, into the first rendition segment in the first rendition comprises:
in response to the image processing model failing to detect presence of moderated content in the second representative image, initiating transcoding of the first mezzanine segment, in the set of mezzanine segments, into the first rendition segment in the first rendition.

9. The method of claim 1:
further comprising:
selecting a second frame temporally preceding the first frame;
characterizing a first motion artifact value, representing visual artifacts indicative of motion, for the second frame; and
in response to the first motion artifact value exceeding a threshold motion artifact value:
selecting a third frame temporally interposed between the second frame and the first frame;
characterizing a second motion artifact value for the third frame; and
in response to the second motion artifact value exceeding the threshold motion artifact value:
selecting the first frame, temporally succeeding the third frame; and
characterizing a third motion artifact value of the first frame; and
wherein extracting the first frame in the first resolution from the video comprises:
in response to the third motion artifact value falling below the threshold motion artifact value, extracting the first frame in the first resolution from the video.

10. The method of claim 1:
further comprising characterizing a first motion artifact value, representing visual artifacts indicative of motion, for the first frame; and
wherein converting the first frame into the first representative image in the second resolution less than the first resolution comprises:
converting the first frame into the first representative image in the second resolution proportional to the first motion artifact value.

11. The method of claim 1:
further comprising:
accessing a transcript of an audio stream associated with the first video; and
extracting a transcript segment, temporally intersecting the first frame, from the transcript of the audio stream; and
wherein serving the first representative image to the image processing model for detection of moderated content in the first representative image comprises:
serving the first representative image and the transcript segment to the image processing model for detection of moderated content in the first representative image.

12. The method of claim 1:
further comprising accessing a policy document defining restricted content for the video player;
wherein serving the first representative image to the image processing model for detection of moderated content in the first representative image comprises:
generating a prompt to generate a moderation score representing compliance with the policy document; and
serving the first representative image, the policy document, and the prompt to the image processing model for detection of moderated content in the first representative image based on restricted content defined by the policy document; and
wherein disabling transcoding of the set of mezzanine segments into rendition segments in the first rendition comprises:
in response to the moderation score, returned by the image processing model, falling below a threshold moderation score, disabling transcoding of the set of mezzanine segments into rendition segments in the first rendition.

13. The method of claim 1:
wherein serving the first representative image to the image processing model for detection of moderated content in the first representative image comprises:
serving the first representative image and a prompt to generate a set of tags representing content in the first representative image to the image processing model;
further comprising prompting the model to scan the set of tags for presence of moderated content; and
wherein disabling transcoding of the set of mezzanine segments into rendition segments in the first rendition comprises:
in response to the image processing model returning detection of moderated content in the first representative image based on the set of tags, disabling transcoding of the set of mezzanine segments into rendition segments in the first rendition.

14. A method comprising:
accessing a video comprising a set of mezzanine segments; and
at a first time, for a first mezzanine segment in the set of mezzanine segments:
extracting a first frame in a first resolution from the first mezzanine segment;
converting the first frame into a first representative image in a second resolution less than the first resolution;
serving the first representative image to an image processing model for detection of moderated content in the first representative image; and
in response to the image processing model returning failure to detect moderated content in the first representative image:
initiating transcoding of the first mezzanine segment, in the set of mezzanine segments, into a first rendition segment in a first rendition; and
enabling distribution of the first rendition segment to a video player.

15. The method of claim 14, further comprising:
at a second time succeeding the first time, for a second mezzanine segment, succeeding the first mezzanine segment, in the set of mezzanine segments:
extracting a second frame in the first resolution from the second mezzanine segment;
converting the second frame into a second representative image in the second resolution;
serving the second representative image to the image processing model for detection of moderated content in the second representative image; and
in response to the image processing model returning detection of moderated content in the second representative image:
disabling transcoding of the second mezzanine segment, in the set of mezzanine segments, into a second rendition segment in the first rendition; and
disabling distribution of the first rendition segment and the second rendition segment to the video player.

16. The method of claim 14:
further comprising receiving a first confidence score from the image processing model, the first confidence score representing confidence of failure to detect moderated content in the second representative image;
wherein initiating transcoding of the first mezzanine segment, in the set of mezzanine segments, into the first rendition segment in the first rendition comprises initiating transcoding of the first mezzanine segment, in the set of mezzanine segments, into the first rendition segment in the first rendition in response to the confidence score exceeding a threshold confidence score; and
further comprising, at a second time succeeding the first time, for a second mezzanine segment in the set of mezzanine segments:
extracting a second frame in the first resolution from the second mezzanine segment;
converting the second frame into a second representative image in a third resolution less than the second resolution;
serving the second representative image to the image processing model for detection of moderated content in the second representative image; and
in response to the image processing model returning detection of moderated content in the second representative image:
disabling transcoding of the second mezzanine segment, in the set of mezzanine segments, into a second rendition segment in the first rendition; and
disabling distribution of the first rendition segment and the second rendition segment to the video player.

17. The method of claim 14, further comprising:
detecting a first scene in the video, the first scene spanning:
the first mezzanine segment; and
a second mezzanine segment succeeding the first mezzanine segment; and
at a second time succeeding the first time:
extracting a second frame, in the first resolution, from the second mezzanine segment;
converting the second frame into a second representative image in the second resolution;
serving the second representative image to the image processing model for detection of moderated content in the second representative image; and
in response to the image processing model failing to detect presence of moderated content in the second representative image:
initiating transcoding of the second mezzanine segment, in the set of mezzanine segments, into the second rendition segment in the first rendition;
initiating transcoding of the third mezzanine segment, in the set of mezzanine segments, into a third rendition segment in the first rendition; and
enabling distribution of the second rendition segment and the third rendition segment to the video player.

18. The method of claim 14:
further comprising:
selecting a second frame temporally preceding the first frame;
characterizing a first motion artifact value, representing visual artifacts indicative of motion, for the second frame; and
in response to the first motion artifact value exceeding a threshold motion artifact value:
selecting a third frame temporally interposed between the second frame and the first frame;
characterizing a second motion artifact value for the third frame; and
in response to the second motion artifact value exceeding the threshold motion artifact value:
selecting the first frame, temporally succeeding the third frame; and
characterizing a third motion artifact value of the first frame; and
wherein extracting the first frame in the first resolution from the video comprises:
in response to the third motion artifact value falling below the threshold motion artifact value, extracting the first frame in the first resolution from the video.

19. The method of claim 14:
further comprising:
extracting a second frame, in the first resolution, from the video, the second frame:
nonconsecutive with the first frame; and
offset from the first frame in the video according to a first frame extraction frequency; and
wherein converting the first frame into the first representative image comprises:
compressing the first frame into a first thumbnail image in the second resolution;
compressing the second frame into a second thumbnail image in the second resolution; and
compositing the first thumbnail image and the second thumbnail image into the first representative image in the second resolution.

20. A method comprising:
accessing a video comprising a set of mezzanine segments;
for each mezzanine segment in the set of mezzanine segments:
extracting a frame in a first resolution from the mezzanine segment;
converting the frame into a representative image, in a set of representative images, in a second resolution less than the first resolution; and
serving the representative image to an image processing model for detection of moderated content in the representative image; and
in response to the image processing model returning failure to detect moderated content in each representative image in the set of representative images:
initiating transcoding of each mezzanine segment, in the set of mezzanine segments, into a first rendition segment, in a set of rendition segments, in a first rendition; and
enabling distribution of the set of rendition segments to a video player.
